(19) United States
(12) Patent Application Publication
(10) Pub. No.: US 2011/0261137 A1
(43) Pub. Date: Oct. 27, 2011

(54) MULTI-BEAM EXPOSURE SCANNING METHOD AND APPARATUS, AND METHOD FOR MANUFACTURING PRINTING PLATE

(76) Inventor: Ichirou Miyagawa, Kanagawa (JP)

(21) Appl. No.: 12/998,792

(22) PCT Filed: Dec. 3, 2009
(86) PCT No.: PCT/JP2009/070631

§ 371 Date: Jun. 2, 2011

(30) Foreign Application Priority Data
Dec. 5, 2008 (JP) 2008-311577

(51) Int. Cl. B41J 2/447

(52) U.S. Cl. 347/233

(57) ABSTRACT

An aspect of the present invention provides a multi-beam exposure scanning method for exposing and scanning same scanning lines a plurality of times by simultaneously irradiating an object with a plurality of light beams to engrave a surface of the object. The method includes a first exposure scanning process of forming a first shape (110), which defines an outline shape of a target planar shape (121) to be left on an exposure surface of the object and an inclined section (122) around the target planar shape (121), with a first beam group, and a second exposure scanning process of forming a second shape (120), which defines a final shape of the target planar shape (121) and the inclined section (122) around the target planar shape (121), by exposing and scanning with a second beam group the same scanning lines as the scanning lines exposed and scanned in the first exposure scanning process.

### TECHNICAL FIELD

The present invention relates to a multi-beam exposure scanning method and apparatus. More particularly, the present invention relates to a multi-beam exposure technique suitable for manufacture of a printing plate, such as a flexographic plate, and to a manufacturing technique of a printing plate, to which the multi-beam exposure technique is applied.

### BACKGROUND ART

Conventionally, there has been disclosed a technique which engraves a recessed shape in the surface of a plate material by using a multi-beam head capable of simultaneously irradiating a plurality of laser beams (Patent Document 1). When a plate is engraved by such multi-beam exposure technique, it is very difficult to stably form fine shapes, such as small dots and thin lines, because of the influence of heat due to the adjacent beams.

In order to solve such problem, Patent Document 1 proposes a configuration which performs so-called interlace exposure to reduce mutual thermal effects between adjacent beam spots in a beam spot array formed on the surface of a plate material. That is, Patent Document 1 adopts a method which forms a plurality of laser spots in the surface of the plate material at intervals of two times or more the engraving pitch corresponding to the engraving density, so as to provide an interval between scanning lines formed in the first exposure scanning, and which exposes, in the second and subsequent scanning, scanning lines between the scanning lines formed in the first exposure scanning.

### CITATION LIST

### Patent Literature

PTL 1: Japanese Patent Application Laid-Open No. 09-85927

### SUMMARY OF INVENTION

### Technical Problem

However, in the method described in Patent Document 1, in order to completely reduce the influence of the adjacent beam, the interval between the beam positions needs to be set sufficiently larger than the beam diameter on the surface of the plate material, and in practice, the interval between the scanning lines needs to be set to correspond to several pixels (several lines). For this reason, the aberration of a lens used in an image forming optical system becomes a problem, which results in such many practical limitations as that it is difficult to form a beam array having precise scanning line intervals, and that the optical system is complicated.

The present invention has been made in view of the above described circumstances. An object of the present invention is to provide a multi-beam exposure scanning method and apparatus, which are capable of effectively reducing the influence of heat generated by the adjacent beam in association with the multi-beam exposure, and which are capable of highly precisely forming a desired shape, such as a fine shape, and to provide a manufacturing method of a printing plate, to which the multi-beam exposure scanning method and apparatus are applied.

### Solution to Problem

In order to achieve the above described object, a multi-beam exposure scanning method according to an aspect of the present invention, which exposes and scans same scanning lines a plurality of times by simultaneously irradiating an object with a plurality of light beams to engrave a surface of the object, is characterized by comprising: a first exposure scanning process of forming a first shape, which defines an outline shape of a target planar shape to be left on an exposure surface of the object and an inclined section around the target planar shape, with a first beam groups; and a second exposure scanning process of forming a second shape, which defines a final shape of the target planar shape and the inclined section around the target planar shape, by exposing and scanning with a second beam group the same scanning lines as those exposed and scanned in the first exposure scanning process.

In the present invention, “an object” may be a recording medium.

In the present invention, it is preferred that the energy of the second beam group irradiated to the object (the recording medium) in the vicinity of the final shape is lower than the energy of the first beam group irradiated to the recording medium. To this end, the output power of the second beam group is controlled to become lower than the output power of the first beam group.

Further, a multi-beam exposure scanning method according to another aspect of the present invention, which exposes and scans same scanning lines a plurality of times by simultaneously irradiating an object with a plurality of light beams to engrave a surface of the object, is characterized by comprising: a first exposure scanning process of forming a first edge section along one direction of a first direction and a second direction different from the first direction with a first beam group, among edge sections of a target planar shape to be left on the exposure surface of the object, and a second exposure scanning process of forming, after the first exposure scanning process, a second edge section along the other direction different from the one direction of the first direction and the second direction with a second beam group.

Further, a multi-beam exposure scanning method according to another aspect of the present invention, which exposes and scans same scanning lines a plurality of times by simultaneously irradiating an object with a plurality of light beams to engrave a surface of the object, is characterized by comprising: a first exposure scanning process of drawing and engraving, with a first beam group, a line drawing of an edge section of a target planar shape to be left on the exposure surface of the object so that only the edge section is formed, and a second exposure scanning process of forming, after the first exposure scanning process, an inclined section around the target planar shape by exposing and scanning the outside region of the line drawing with a second beam group.

Further, a multi-beam exposure scanning method according to another aspect of the present invention, which exposes and scans same scanning lines a plurality of times by simultaneously irradiating an object with a plurality of light beams to engrave a surface of the object, is characterized in that when a target planar shape region to be left on an exposure surface of the object and a peripheral region of the target planar shape region are set as a first region and the region outside the first region is set as a second region, in that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and in that the second region is subjected to non-interlace exposure which performs engraving with a beam group having an adjacent beam interval equal to the scanning line interval.

### Advantageous Effects of Invention

According to the present invention, the influence of heat in the vicinity of the surface shape to be left can be reduced in such a manner that the roles in the engraving are shared by each of the scanning exposure operations performed a plurality of times, and that beam power control, exposure position control, and the like, are performed in each of the exposure scanning processes. Thereby, it is possible to form a desired surface shape and inclined section (slope) with high precision.

### BRIEF DESCRIPTION OF DRAWINGS

FIG. 1 shows a configuration of a platemaking apparatus to which a multi-beam exposure scanning apparatus according to an embodiment of the present invention is applied;

FIG. 2 shows a configuration of an optical fiber array section arranged in an exposure head;

FIG. 3 is an enlarged view of the optical fiber array section;

FIG. 4 is a schematic diagram of an image forming optical system of the optical fiber array section;

FIG. 5 is an illustration showing an example of arrangement of optical fibers in the optical fiber array section and a relationship between the optical fibers and the scanning lines;

FIG. 6 is a plan view showing an outline of a scanning exposure system in the platemaking apparatus according to the present embodiment;

FIG. 7 is a block diagram showing a configuration of a control system of the platemaking apparatus according to the present embodiment;

FIGS. 8A to 8D are illustrations for explaining a scanning sequence of exposure in a first embodiment;

FIGS. 9A and 9B are illustrations in the case of engraving a fine rectangular shape in the surface of a plate material by the first embodiment;

FIG. 10 is a graph showing an example of laser output control in the first embodiment;

FIGS. 11A and 11B are illustrations in the case of engraving a fine rectangular shape in the surface of a plate material by a second embodiment;

FIG. 12 is a graph showing an example of laser output control in the second embodiment;

FIGS. 13A and 13B are illustrations in the case of engraving a fine rectangular shape in the surface of a plate material by a third embodiment;

FIG. 14 is a schematic view showing an arrangement form of optical fibers suitable for spiral exposure according to a fourth embodiment and a relationship between optical fibers and scanning lines;

FIGS. 15A and 15B are schematic views showing an outline of a scanning exposure system according to a fifth embodiment;

FIG. 16 is a schematic view showing a relationship between a region to be left on the surface of a plate material, scanning lines, and beam positions (channels) in the fifth embodiment;

FIG. 17 is an illustration showing a region exposed by the first scanning operation according to the fifth embodiment;

FIG. 18 is an illustration showing a region exposed by the second scanning operation according to the fifth embodiment;

FIG. 19 is an illustration showing shapes formed by respective scanning operations in the fifth embodiment;

FIG. 20 is a schematic view showing an outline of a scanning exposure system according to a sixth embodiment;

FIG. 21 is an illustration showing a region exposed by the first scanning operation according to the sixth embodiment;

FIG. 22 is an illustration showing a region exposed by the second scanning operation according to the sixth embodiment;

FIG. 23 is an illustration showing a region exposed by the third scanning operation according to the sixth embodiment;

FIG. 24 is an illustration of shapes formed by respective scanning operations in the sixth embodiment; and

FIGS. 25A to 25 C are illustrations showing an outline of a plate making process of a flexographic plate.

### DESCRIPTION OF EMBODIMENTS

In the following, embodiments according to the present invention will be described in detail with reference to the accompanying drawings.

### <Configuration Example of Multi-Beam Exposure Scanning Apparatus>

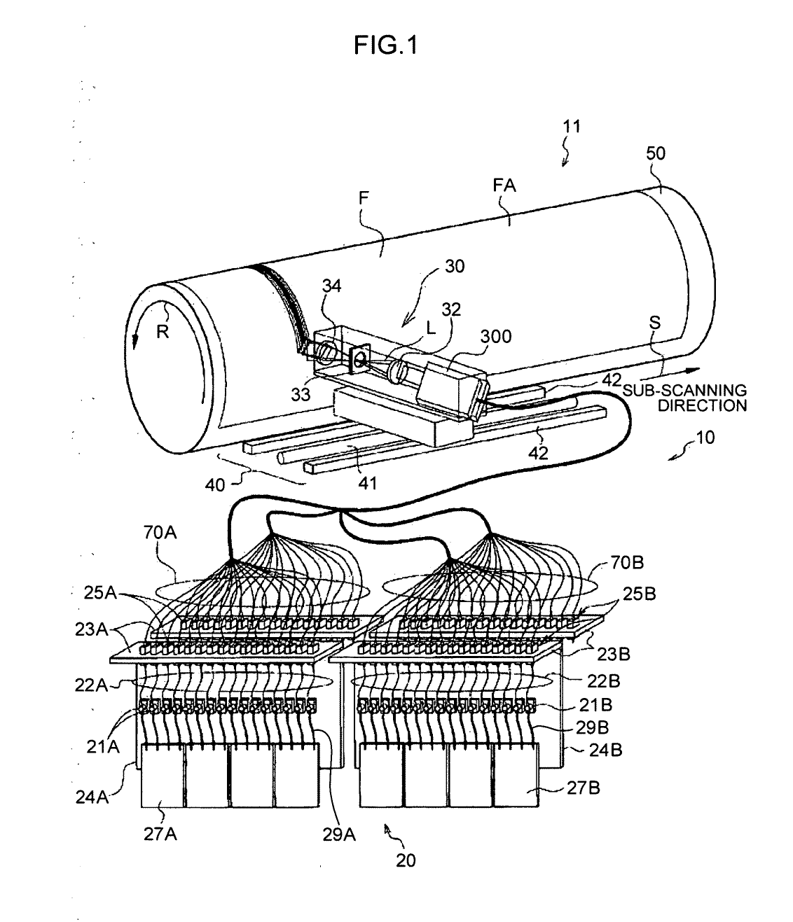

FIG. 1 shows a configuration of a platemaking apparatus to which a multi-beam exposure scanning apparatus according to an embodiment of the present invention is applied. A platemaking apparatus 11 shown in FIG. 1 is configured to engrave (record) a two-dimensional image in the surface of a sheet-like plate material (corresponding to a “recording medium”) at high speed in such a manner that the plate material F is fixed on the outer peripheral surface of a drum 50 having a cylindrical shape, that the drum 50 is rotated in the arrow R direction (main scanning direction) in FIG. 1, that a plurality of laser beams corresponding to image data of the image to be engraved (recorded) in the plate material F are irradiated from an exposure head 30 of a laser recording apparatus 10 toward the plate material F, and that the exposure head 30 is scanned in the sub-scanning direction (the arrow S direction in FIG. 1) perpendicular to the main scanning direction at a predetermined pitch. Here, a case where a rubber plate or a resin plate used for flexographic printing will be described as an example.

The laser recording apparatus 10 used in the platemaking apparatus 11 according to the present embodiment is configured by including a light source unit 20 which generates a plurality of laser beams, the exposure head 30 which irradiates the plurality of laser beams generated by the light source unit 20 onto the plate material F, and an exposure head movement section 40 which moves the exposure head 30 along the sub-scanning direction.

The light source unit 20 includes a plurality of semiconductor lasers 21A and 21B (here a total of 64 pieces), and the light beams of the respective semiconductor lasers 21A and 21B are individually transmitted to an optical fiber array section 300 of the exposure head 30 via optical fibers 22A, 22B, 70A, and 70B, respectively.

In the present embodiment, a broad area semiconductor laser (wavelength: 915 nm) is used as the semiconductor lasers 21A and 21B, and the semiconductor lasers 21A and 21B are arranged side by side on light source substrates 24A and 24B.

Each of the semiconductor lasers 21A and 21B are individually coupled to one end section of each of the optical fibers 22A and 22B. The other end of each of the optical fibers 22A and 22B is connected to an adapter of each of SC type optical connectors 25A and 25B.

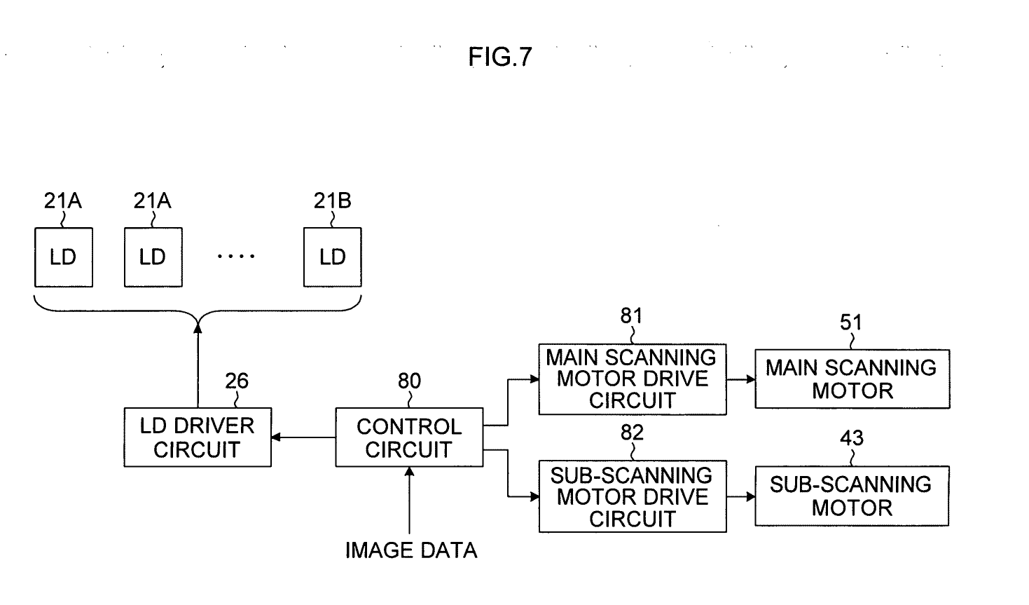

Adapter substrates 23A and 23B which support the SC type optical connectors 25A and 25B are attached perpendicularly to one end section of the light source substrates 24A and 24B, respectively. Further, LD driver substrates 27A and 27B, on each of which an LD driver circuit (not shown in FIG. 1 and designated by reference numeral 26 in FIG. 7) for driving the semiconductor laser 21A and 21B is mounted, are attached to the other end sections of the light source substrates 24A and 24B. The semiconductor lasers 21A and 21B are respectively connected to the corresponding LD driver circuits via individual wiring members 29A and 29B, so that each of the semiconductor lasers 21A and 21B is individually driven.

Note that in the present embodiment, a multimode optical fiber having a relatively large core diameter is applied to the optical fibers 70A and 70B in order to increase the output of the laser beam. Specifically, an optical fiber having a core diameter of 105 μm is used in the present embodiment. Further, a semiconductor laser having a maximum output of about 10 W is used for the semiconductor lasers 21A and 21B. Specifically, it is possible to adopt, for example, a semiconductor laser (6398-L4) which is marketed by JDS Uniphase Company and which has a core diameter of 105 μm and an output of 10 W, or the like.

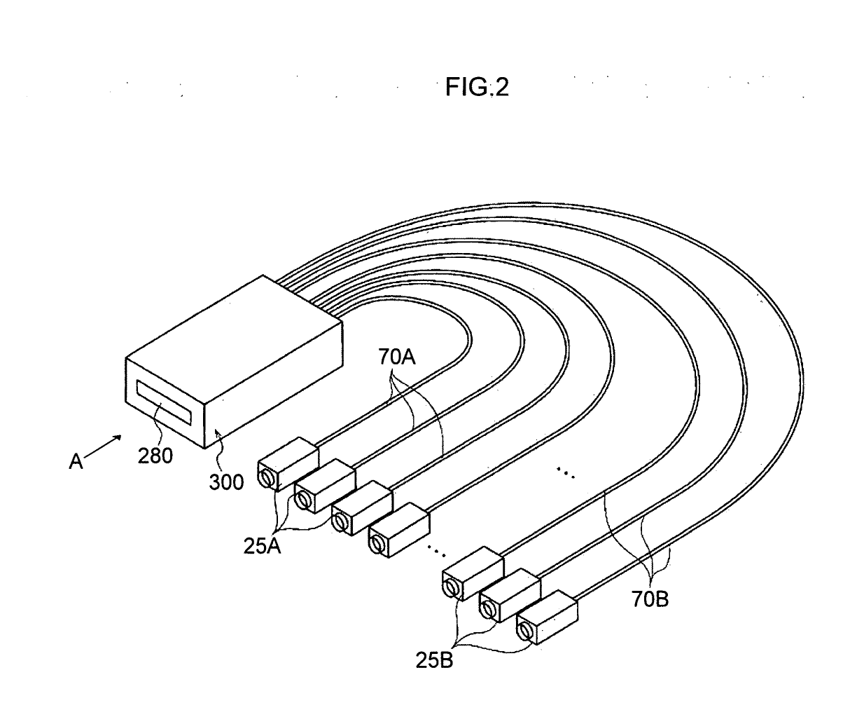

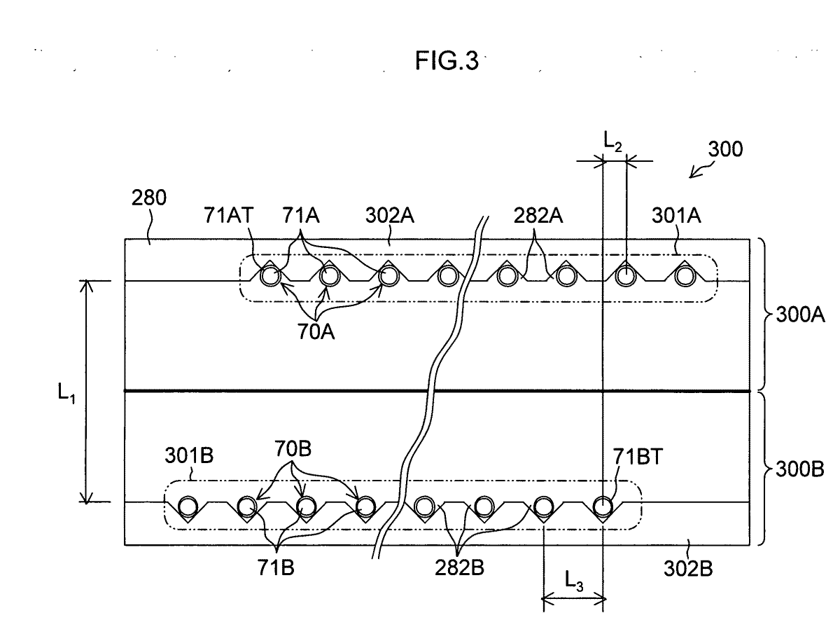

On the other hand, the exposure head 30 includes the optical fiber array section 300 which collects and emits the respective laser beams emitted from the plurality of semiconductor lasers 21A and 21B. The light emitting section (not shown in FIG. 1 and designated by reference numeral 280 in FIG. 2) of the optical fiber array section 300 has a configuration in which the emitting ends of the 64 optical fibers 70A and 70B led from the respective semiconductor lasers 21A and 21B are arranged side by side in two rows of the 32 emitting ends (see FIG. 3).

Further, in the exposure head 30, a collimator lens 32, an opening member 33, and an image forming lens 34 are provided side by side in this order from the side of the light emitting section of the optical fiber array section 300. An image forming optical system is configured by combining the collimator lens 32 and the image forming lens 34. The opening member 33 is arranged so that its opening is positioned at a Far Field position when seen from the side of the optical fiber array section 300. Thereby, the same light quantity restricting effect can be given to all the laser beams emitted from the optical fiber array section 300.

The exposure head movement section 40 includes a ball screw 41 and two rails 42, whose longitudinal direction is arranged along the sub-scanning direction. Thus, when a sub-scanning motor (not shown in FIG. 1 and denoted by reference numeral 43 in FIG. 7) for driving and rotating the ball screw 41 is operated, the exposure head 30 arranged on the ball screw 41 can be moved in the sub-scanning direction in the state of being guided by the rails 42. Further, when a main scanning motor (not shown in FIG. 1 and denoted by reference numeral 51 in FIG. 7) is operated, the drum 50 can be rotated in the arrow R direction in FIG. 1, and thereby the main scanning is performed.

FIG. 2 shows a configuration of the optical fiber array section 300, and FIG. 3 is an enlarged view (view A in FIG. 2) of the light emitting section 280 of the optical fiber array section 300. As shown in FIG. 3, the light emitting section 280 of the optical fiber array section 300 is configured by optical fiber array units 300A and 300B combined in two upper and lower stages, and is configured such that two rows of the 32 optical fibers designated by reference characters 70A and 70B, each of which optical fibers has the same core diameter of 105 μm, are arranged side by side in the upper and lower stages, respectively.

The optical fiber array section 300 has two bases (V-groove substrates) 302A and 302B. In one surface of the respective bases 302A and 302B, the same number of V-shaped grooves 282A and 282B as the semiconductor lasers 21A and 21B, that is, 32 V-shaped grooves are respectively formed so as to be adjacent to each other at predetermined intervals. Further, the bases 302A and 302B are arranged so that V-shaped grooves 282A and 282B face each other.

An optical fiber end section 71A as the other end section of each of the optical fibers 70A is fitted into each of the V-shaped grooves 282A of the base 302A. Similarly, an optical fiber end section 71B as the other end section of each of the optical fibers 70B is fitted into each of the V-shaped grooves 282B of the base 302B. That is, the optical fiber array section 300 according to the present embodiment is configured in such a manner that optical fiber end section groups 301A and 301B respectively configured by linearly arranging the plurality of optical fiber end sections 71A and 71B (a total of 64 pieces=32 pieces×2 in the present embodiment) along a predetermined direction are provided in two rows in parallel with the direction perpendicular to the predetermined direction.

Therefore, a plurality of (32×2) laser beams are simultaneously emitted from the light emitting section 280 of the optical fiber array section 300.

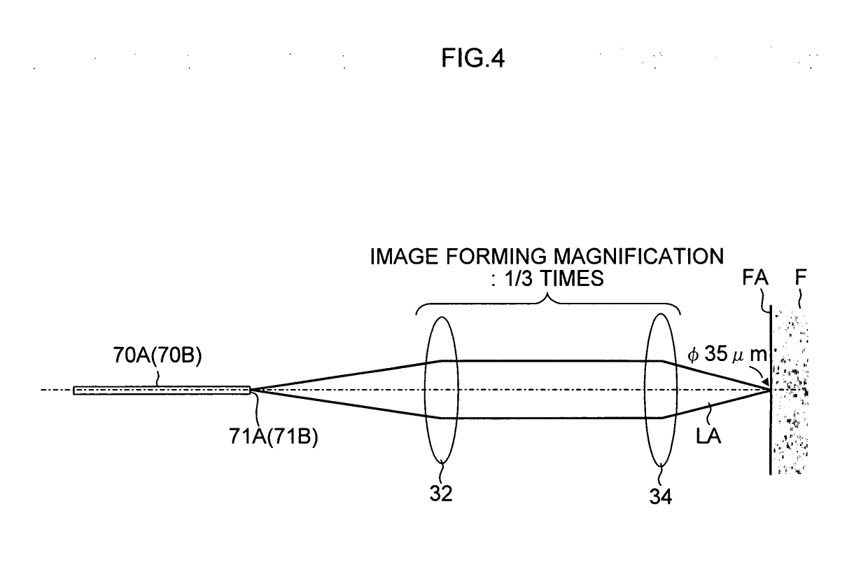

FIG. 4 is a schematic diagram of the image forming system of the optical fiber array section 300. As shown in FIG. 4, an image of the light emitting section 280 of the optical fiber array section 300 is formed in the vicinity of the exposure surface (surface) FA of the plate material F at a predetermined image forming magnification by the image forming device configured by the collimator lens 32 and the image forming lens 34. In the present embodiment, the image forming magnification is set to ⅓. Thereby, the spot diameter of a laser beam LA emitted from the optical fiber end sections 71A and 71B having the core diameter of 105 μm is set to φ35 μm.

In the exposure head 30 having such image forming system, when the interval (L1 in FIG. 3) between the upper and lower stages of the optical fiber array units 300A and 300B described with reference to FIG. 3, the relative position between the adjacent optical fibers in the row direction (L2 in FIG. 3), the interval between the adjacent optical fibers in the row (L3 in FIG. 3), and the inclination angle (angle θ in FIG. 5) of the arrangement direction (array direction) of the optical fiber end section groups 301A and 301B at the time of fixing the optical fiber array section 300 are suitably designed, an interval P1 between scanning lines (recording lines) K exposed by the laser beams emitted from the optical fiber end sections 71A and 71B arranged at adjacent positions in each of the rows of the array upper stage (optical fiber end section group 301A) and the array lower stage (optical fiber end section group 301B), and an interval P2 between scanning lines K exposed by an optical fiber end section 71AT at the right end of the array upper stage and an optical fiber end section 71BT at the left end of the array lower stage can be equally set to 10.58 μm (corresponding to a resolution of 2400 dpi in the sub-scanning direction), respectively, as shown in FIG. 5. Note that in FIG. 5, the number of optical fibers is reduced for convenience of illustration. That is, a scanning line interval (P1=P2≈10.6 μm) corresponding to the sub-scanning direction resolution of 2400 dpi can be realized in the 64 channels based on such design of the optical fiber array section 300.

When the exposure head 30 having the above described configuration is used, it is possible to scan and expose a range of 64 lines (one swath) at the same time by the two rows of the optical fiber end section groups 301A and 301B of the optical fiber array section 300.

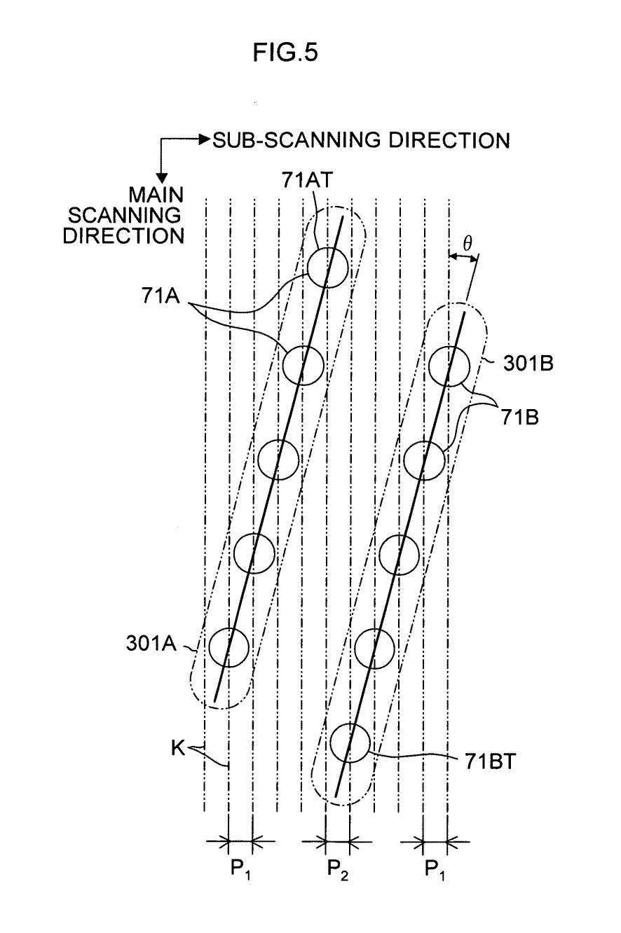

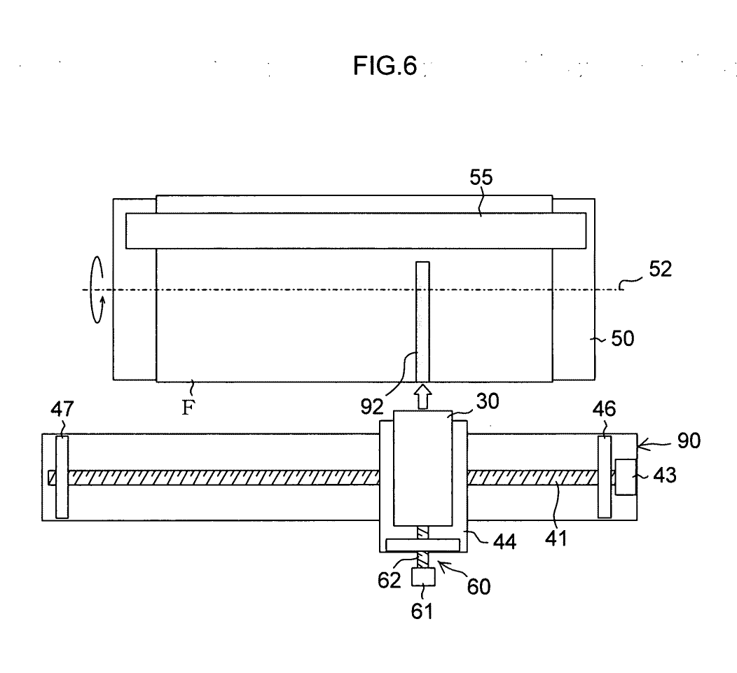

FIG. 6 is a plan view showing an outline of a scanning exposure system in the platemaking apparatus 11 shown in FIG. 1. The exposure head 30 includes a focus position changing mechanism 60 and an intermittent feeding mechanism 90 which performs feeding in the sub-scanning direction.

The focus position changing mechanism 60 has a motor 61 and a ball screw 62, which move the exposure head 30 back and forth with respect to the surface of the drum 50, and is capable of moving the focus position by about 300 μm for about 0.1 second by the control of the motor 61. The intermittent feeding mechanism 90 configures the exposure head movement section 40 described with reference to FIG. 1, and has the ball screw 41 and the sub-scanning motor 43 for rotating the ball screw 41 as shown in FIG. 6. The exposure head 30 is fixed to a stage 44 on the ball screw 41, and can be intermittently fed by the control of the sub-scanning motor 43 in the axial line 52 direction of the drum 50 by one swath (640 μm) for about 0.1 second so as to reach the adjacent swath.

Note that in FIG. 6, reference numerals 46 and 47 denote bearings rotatably supporting the ball screw 41. Reference numeral 55 denotes a chuck member for chucking the plate material F on the drum 50. The position of the chuck member 55 is set in a non-recording region where exposure (recording) is not performed by the exposure head 30. While the drum is rotated, the laser beams of 64 channels are irradiated from the exposure head 30 onto the plate material F on the rotating drum 50. Thereby, an exposure range 92 corresponding to the 64 channels (one swath) is exposed without gaps, so that the surface of the plate material F is engraved (image recorded) by one swath width. When the chuck member 55 is then made to pass through the front of the exposure head 30 by the rotation of the drum 50 (in the non-recording region of the plate material F), the exposure head 30 is intermittently fed in the sub-scanning direction, so that next one swath is exposed. A desired image is formed on the whole surface of the plate material F by repeating the exposure and scanning based on the above described intermittent feeding in the sub-scanning direction.

In the present embodiment, the sheet-like plate material F is used, but a cylindrical recording medium (sleeve type) can also be used.

### <Configuration of Control System>

FIG. 7 is a block diagram showing a configuration of a control system of the platemaking apparatus 11. As shown in FIG. 7, the platemaking apparatus 11 includes the LD driver circuit 26 which drives the respective semiconductor lasers 21A and 21B according to two-dimensional image data to be engraved, the main scanning motor 51 which rotates the drum 50, a main scanning motor drive circuit 81 which drives the main scanning motor 51, a sub-scanning motor drive circuit 82 which drives the sub-scanning motor 43, and a control circuit 80. The control circuit 80 controls the LD driver circuit 26 and each of the motor drive circuits (81, 82).

Image data representing an image to be engraved (recorded) in the plate material F are supplied to the control circuit 80. On the basis of the image data, the control circuit 80 controls the drive of the main scanning motor 51 and the sub-scanning motor 43, and individually controls the output (performs the laser beam power control) of each of the semiconductor lasers 21A and 21B. Note that a device to control the output of the laser beam is not limited to a mode of controlling the quantity of light emitted from the semiconductor lasers 21A and 21B. In place of the mode, or in combination with the mode, an optical modulation device such as an acoustic optical modulator (AOM) module may also be used.

Next, there will be described an exposure scanning process at the time of manufacturing a printing plate by the multi-beam exposure system.

### First Embodiment

In a first method using the multi-beam exposure system which exposes and scans the same scanning lines a plurality of times, an outline of a planar shape to be left on the surface of a recording medium and an outline of an inclined section of the planar shape are formed with a first beam group (rough engraving process), and after the temperature of the plate material F increased in the rough engraving process is reduced to a predetermined temperature, the same scanning lines are exposed and scanned with a second beam group, so that a final shape (of the target surface shape and the inclined section thereof) is precisely formed by fine engraving (fine engraving process). Here, it is preferred that the energy of the second beam group irradiated to the recording medium in the vicinity of the final shape is lower than the energy of the first beam group irradiated to the recording medium. To this end, the output power of the second beam group is controlled to become lower than the output power of the first beam group. In this way, the multiple-time scanning exposure system is adopted in which the roles of engraving (rough engraving and fine engraving) are shared by the respective beam groups at the time of scanning and exposing the same scanning line the plurality of times.

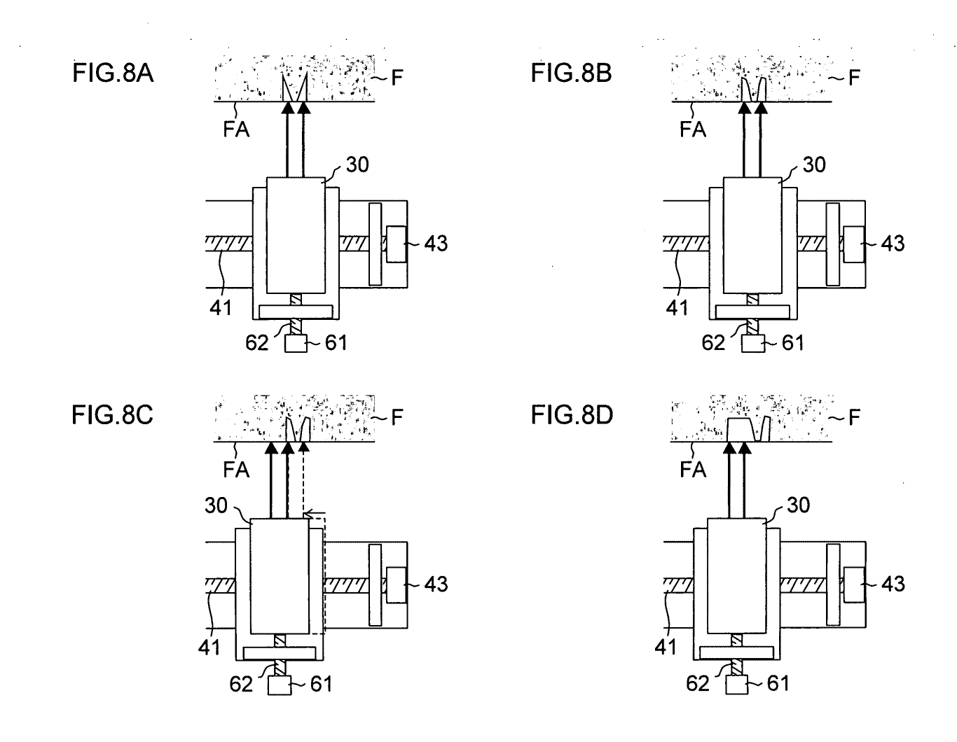

The exposure scanning sequence will be described with reference to FIGS. 8A to 8D.

First, the first shape is engraved by exposing and scanning the plate material F with the first beam group (64 channels) emitted from the exposure head 30 while the drum 50 is rotated at a constant speed (FIG. 8A). The first scanning exposure process with the first beam group is a rough engraving process which does not form a surface shape to be finally left as a convex planar section and an inclined section of the convex planar section. When the drum 50 is rotated once, the rough engraving is performed with the width of 64 channels. Then, at the same sub-scanning position (without moving the exposure head 30), the scanning and exposure is performed on the same lines at the same positions during the second rotation of the drum 50 by using the second beam group having lower power (the same channels as the first beam group), so that the final shape (second shape) is formed (FIG. 8B).

After the engraving by one swath is completed by two rotations of the drum 50, when the chuck member 55 as a non-recording region passes through the front of the exposure head 30, the exposure head 30 is intermittently fed in the sub-scanning direction (in the left direction in FIGS. 8A to 8D), so as to be moved to the position where the engraving of the next adjacent one swath is performed. Then, similarly to FIG. 8A, the rough engraving using the first beam group is performed at this position (FIG. 8C). Then, the scanning and exposure of the fine engraving is again performed by the second beam group (the same channels as the first beam group) being scanned on the same lines at the same positions, so that the final shape is formed (FIG. 8D)). Thereafter, the above described processes are repeated, so that the whole surface of the plate material F is exposed.

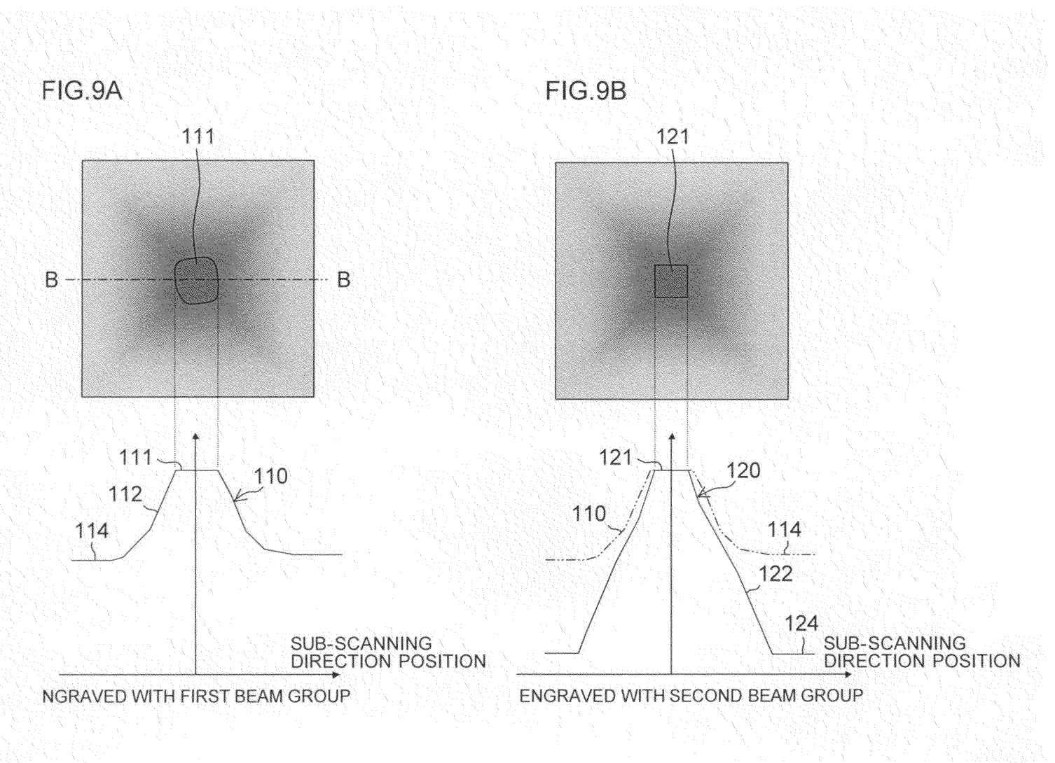

FIGS. 9A and 9B are illustrations in the case of engraving a fine rectangular shape in the surface of the plate material F. FIG. 9A shows a shape (first shape) 110 obtained by the rough engraving with the first beam group. FIG. 9B shows a final shape (second shape) 120 obtained by the fine engraving with the second beam group. As shown in FIG. 9B, the target final shape 120 is assumed to be formed by engraving the surface of the plate material F in such a manner that a fine rectangular planar section 121 (here, a square having one side of about four pixels) is left on the surface, and that an inclined section 122 around the rectangular planar section 121 and further a flat bottom section 124 around the inclined section 122 are formed.

As shown in FIG. 9A, the laser power of the corresponding channels of the exposure head 30 is first controlled so that a slightly rough almost rectangular surface section 111 is left by the exposure scanning with the first beam group. The lateral direction in FIG. 9A represents the position in the sub-scanning direction. The laser output of the channels corresponding to the positions of the surface section 111 is turned off, and the laser output of the channels corresponding to an inclined section 112 and a bottom section 114 is set to the power corresponding to the depth to be engraved.

Next, the surface of the first shape 110 is exposed and scanned by the second beam group. In the second exposure, the laser output power of corresponding channels is set lower than the laser output power in the first exposure so that the surface section 111 and the inclined section 112 of the first shape 110 are slightly removed as shown in FIG. 9B).

The temperature increased at the time of the first engraving with the first beam group is reduced to a predetermined temperature until the second scanning exposure, and thereafter fine engraving is performed at the low power with the second beam group. Thus, it is possible to suppress the temperature rise of the surface section to be left. Thereby, the influence of heat is reduced, so that a precise rectangular shape (rectangular planar section 121) can be obtained and the sharp (steep) inclined section 122 can be formed.

Further, the bottom section 124 outside the inclined section 122 is engraved with the same power as that at the time of the first engraving, so as to thereby be deeply engraved to a depth about twice the depth of the first bottom section 114.

Generally, a deep engraving with a depth of about 500 μm (depth of the recessed section) is preferred in a highly precise flexographic plate. According to the present embodiment, such deep engraving can be performed in the configuration in which the same scanning lines are exposed and scanned a plurality of times.

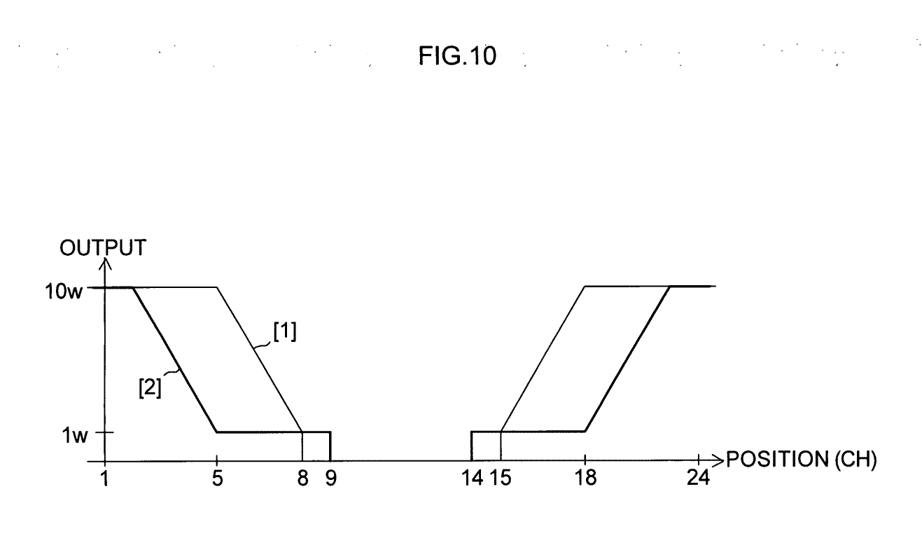

FIG. 10 is a graph which exemplifies laser outputs at the time of the first exposure and the second exposure along the line B-B (at the position y=yB in the main scanning direction) in FIG. 9A. In FIG. 10, the abscissa represents the channel position (position in the sub-scanning direction) of optical fibers in the optical fiber array section 300, and the ordinate represents the laser output (W). The thin line (reference numeral [1]) represents the laser output of the first beam group, and the thick line (reference numeral [2]) represents the laser output of the second beam group. Here, for the sake of brevity of description, the range of channels of ch1 to ch24 is illustrated, and the maximum power is set to 10 W. However, the channels to be used are different according to the image data to be engraved, and the outputs are also different in dependence upon the apparatus configuration, or the like.

In FIG. 10, the output of the channels of ch1 to ch5 and ch18 to ch24 of the first beam group is set to 10 W, and the bottom section 114 in FIG. 9A is engraved by these channels. Further, the output of the channels of ch9 to ch14 of the first beam group is set to 0 W (turned off), and these channels correspond to the positions of the surface section 111 in FIG. 9A. The output of the channels of ch6 to ch8 and ch15 to ch17 corresponding to the inclined section 112 is set in the range of 1 W or more to less than 10 W and gradually increased or decreased in correspondence with the channel positions. The first shape 110 described with reference to FIG. 9A is obtained by such power control (reference numeral [1]) of each of the channels.

In the second beam group at the time of the second exposure, as designated by reference numeral [2] in FIG. 10, the output of the channels ch5 to ch9 and ch14 to ch18 is set to 1 W, and the output of the channels ch10 to ch13 is set to 0 W (turned off). Thereby, the shape of the rectangular planar section 121 described with reference to FIG. 9B can be highly precisely formed, and the steep inclined section 122 can be formed.

When it is assumed that the laser output (beam light quantity) at the time of the first scanning exposure with the first beam group is expressed as PW1(i, x) which is a function of the number i of each channel (ch) and the sub-scanning direction position x of the exposure head 30, and that the laser output at the time of the second scanning exposure with the second beam group for exposing the same lines at the same positions as those exposed by the first beam group is expressed as PW2(i, x), the power of the laser output PW2(i, x) of the second beam group in the channels (ch5 to ch8 and ch15 to ch18 in FIG. 10) near the outside of the channels (ch9 and ch14 in the case of FIG. 10) used to engrave the boundary of the region to be finally left as the surface shape (rectangular planar section 121 in FIG. 9B), is set lower than the power of the laser output PW1 (i, x) of the first beam group (PW2(i, x)≦PW1(i, x)). However, in the embodiment described with reference to FIG. 1, the number is set as i=1 to 64, and the position x can be expressed by the number of feed steps (x=0, 1, 2 . . . ) of intermittent feeding based on the sub-scanning feed amount corresponding to the swath pitch sp as a unit.

Further, the channels (ch9 and ch14 in the case of FIG. 10) used to engrave the boundary of the region to be left as the final surface shape (rectangular planar section 121 in FIG. 9B) is set to the minimum output (1 W in FIG. 10) through a plurality of times of the scanning exposure process.

The temperature rise in the surface section of the final shape can be suppressed by such power control, so that the surface planar section can be highly precisely formed and also the edge section can be made steep.

Note that the specific mode of power control is different according to the sensitivity (reactivity to light) of the plate material (flexographic sensitized material) to be used. Suitable output conditions are experimentally determined according to the kind of plate material, and the like.

### Second Embodiment

In a second method using the multi-beam exposure system which exposes and scans the same scanning lines a plurality of times, the edge section along the main scanning direction or the edge section along the sub-scanning direction, among the edge sections of the final shape to be left on the exposure surface of the recording medium, is formed with a first beam group (first direction edge forming process), and after the temperature increased by the first direction edge forming process is reduced to a predetermined temperature, the edge section perpendicular to the first direction edge is formed with a second beam group (second direction edge forming process), so that a desired final shape (a surface shape and an inclined section) is obtained. In this way, a multiple-time scanning exposure system is adopted in which the roles of engraving (roles of forming the edge section along the first direction and the edge section along the second direction) are shared by the respective beam groups in a plurality of times of scanning and exposure.

It is difficult to simultaneously form the edges in both the main scanning direction and the sub-scanning direction with high precision, and hence the edges in the respective directions are formed by dividing the edge forming process into a plurality of exposure processes. That is, when two perpendicular edges of a corner section are to be formed by one exposure process, it is difficult to excellently reproduce the edges due to the influence of heat generated by the adjacent beams. However, when the process of forming the edges in the respective directions is divided into the exposure process with the first beam group and the exposure process with the second beam group so as to be shared as in the above described second method, it is possible to suppress the temperature rise in the surface section to be left. Thereby, the surface planar section having a desired shape can be left, and the edge can also be made steep.

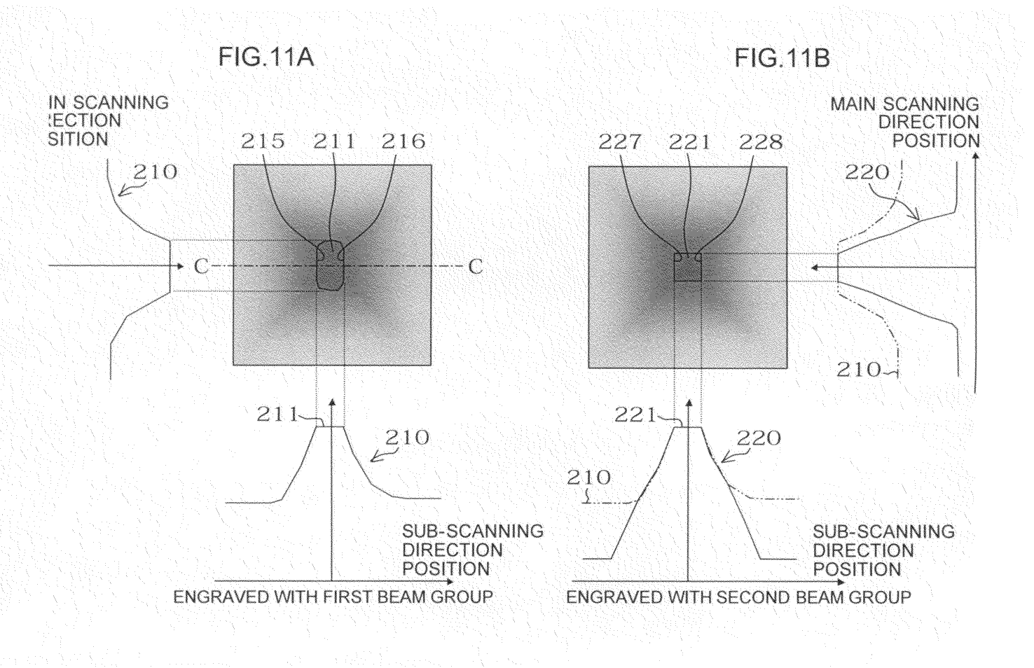

FIGS. 11A and 11B are illustrations in the case of engraving a fine rectangular shape in the surface of the plate material F by the second method. FIG. 11A shows a shape (first shape) 210 obtained with the first beam group. FIG. 11B shows a final shape (second shape) 220 obtained with the second beam group.

Here, the laser output of the corresponding channels is controlled so that linear edges (right and left edges of a surface section 211 in FIG. 11A) 215 and 216 along the main scanning direction are formed with the first beam group at the time of the first scanning exposure. The laser output for the upper and lower sides along the sub-scanning direction is turned off at the main scanning direction positions located sufficiently outside the positions of edges 227 and 228 of the final target surface shape (reference numeral 221 in FIG. 11B). In this way, the first shape 210 shown in FIG. 11A is obtained.

Next, the surface of the first shape 210 is exposed and scanned with the second beam group. In the second exposure, the laser output of corresponding channels is controlled so that the linear edges (upper and lower edges of the rectangular planar section 221 in FIG. 11B) 227 and 228 along the sub-scanning direction are formed as shown in FIG. 11B.

Note that the linear edges 215 and 216 along the main scanning direction are formed with the first beam group at the time of the first scanning exposure, and hence, in the second beam group, the laser output is turned off from the channels at the sub-scanning direction positions outside the positions of the edges 215 and 216.

Each of the edges in the respective directions is individually formed by dividing the process of forming the edges into the plurality of scanning exposure processes in this way. Thereby, the surface shape to be finally left can be formed with high precision, and the edges can also be made steep. Further, also in the second method, the recessed section can be deeply engraved similarly to the first method described with reference to FIG. 9.

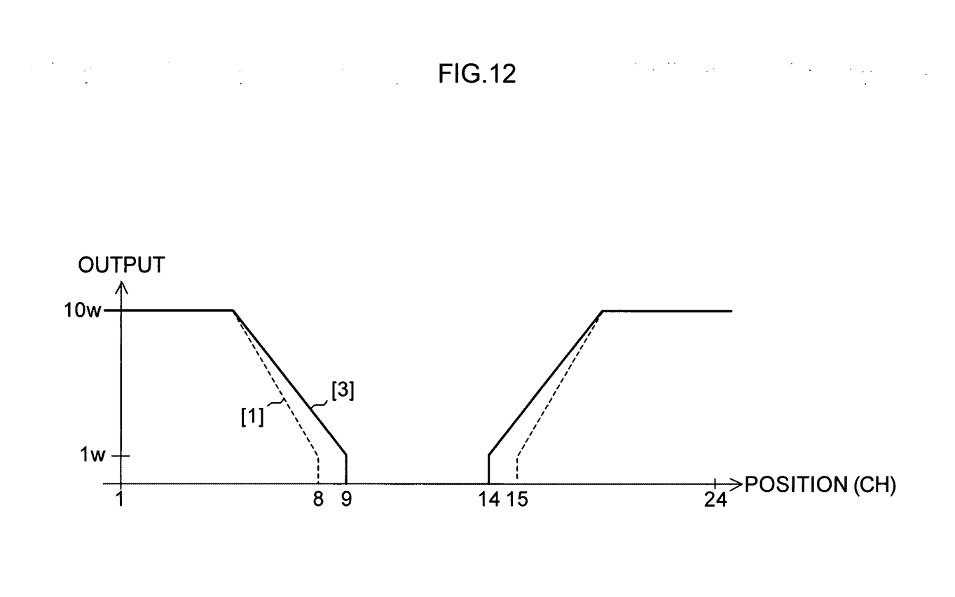

FIG. 12 is a graph which exemplifies laser outputs at the time of the first exposure along the line C-C in FIG. 11A. In FIG. 12, the abscissa represents the channel position (the position in the sub-scanning direction) of optical fibers in the optical fiber array section 300, and the ordinate represents the laser output (W). For comparison, the laser output (reference numeral [1]) of the first beam group in “embodiment 1” described with reference to FIG. 10 is represented by the broken line in FIG. 12. In the case of “embodiment 2”, as represented by the solid line (reference numeral [3]) in FIG. 12, in order to complete the edges of the final line shape along the main scanning direction by the first exposure, the output of channels of ch9 and ch14 used to engrave the boundary of the final line shape is set to 1 W.

Note that a mode can also be adopted, in which the edge of the line along the sub-scanning direction is formed with the first beam group, and in which the edge of the line along the main scanning direction is formed with the second beam group.

### Third Embodiment

In a third method using the multi-beam exposure system which exposes and scans the same scanning lines a plurality of times, a final surface shape to be left on the exposure surface of a recording medium is formed by exposing thin lines with a first beam group of low power so that only the edge section of the final surface shape is formed (contour line engraving process), and after the temperature increased by the contour line engraving process is reduced to a predetermined temperature, an inclined section is formed by exposing and scanning the outside of the thin lines (contour lines) with a second beam group (inclined section engraving process).

In this way, a multiple-time scanning exposure method is adopted in which the roles of engraving (roles of forming the contour line and the inclined section) are shared by the respective beam groups in a plurality of times of scanning and exposure.

Thereby, the influence of heat on the surface section to be left can be suppressed, so that the precision of the shape of the surface planar section can be improved and the edge can also be made steep.

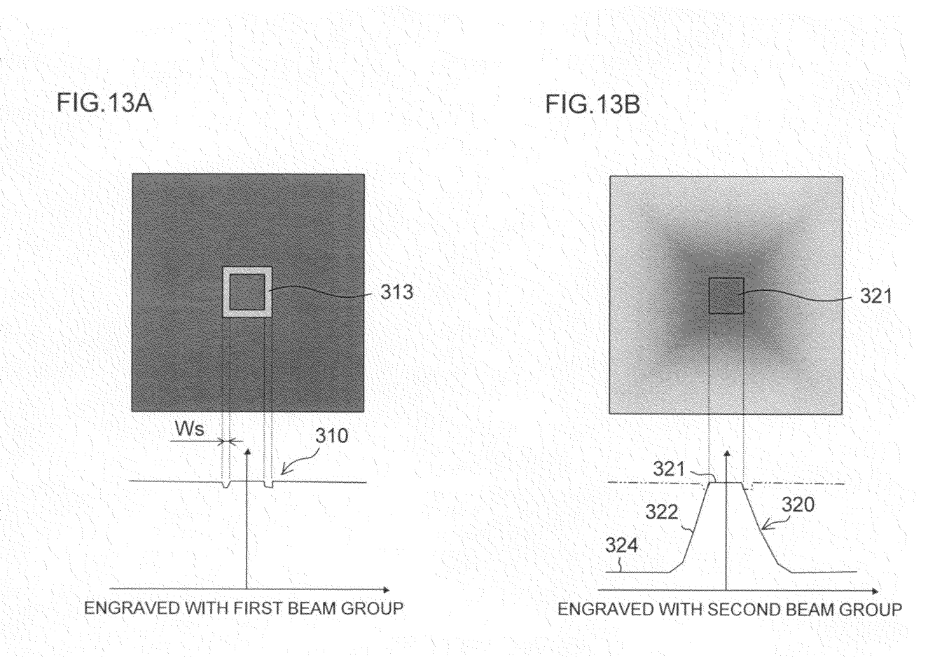

FIGS. 13A and 13B are illustrations in the case of engraving a fine rectangular shape in the surface of the plate material F by the third method. FIG. 13A shows a shape (first shape) 310 obtained with the first beam group. FIG. 13B shows a final shape (second shape) 320 obtained with the second beam group. At the time of the first scanning exposure, only thin lines (grooves 313) for defining the contour shape of a final rectangular planar section 321 are formed with a first beam group of a low laser output (for example, 1 W) as shown in FIG. 13A. For example, the width Ws of the groove 313 is generally set to about 10 μm to 30 μm.

Thereafter, at the time of the second scanning exposure, the region outside the groove 313 is engraved with the second beam group to reach the portion of the groove 313, so that an inclined section 322 and a bottom section 324 are formed as shown in FIG. 13B.

The shape formed in this way can be adopted as the final shape. It is also possible to engrave the inclined section 322 more steeply or to engrave the bottom section 324 more deeply by the third and subsequent scanning exposure processes.

### Fourth Embodiment

### Regarding Apparatus Configuration of Spiral Exposure System

In the practice of the present invention, the exposure system is not limited to the scanning exposure system based on the intermittent feeding in the sub-scanning direction as described with reference to FIGS. 1 to 8, and there may also be adopted a spiral exposure system which scans the surface of the plate material F in a spiral pattern by moving the exposure head 30 with a constant speed in the sub-scanning direction while the drum is rotated.

The configuration of the multi-beam exposure scanning apparatus based on the spiral exposure system is substantially in common with the configuration described with reference to FIG. 1. The common components are described by using the same reference numerals and characters.

The apparatus of the spiral exposure system is mainly different from the apparatus of the intermittent feeding system in the scanning and driving method in which the exposure head 30 is moved in the sub-scanning direction with a constant speed during one rotation of the drum 50, and in the form of arrangement of the optical fibers in the optical fiber array section 300.

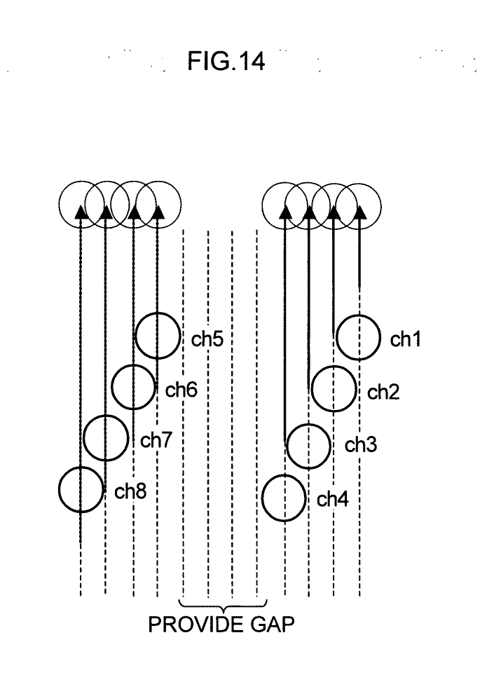

FIG. 14 is a schematic view showing a suitable arrangement form of optical fibers in the case of performing the spiral exposure and a relationship between the optical fibers and the scanning lines. Here, for the sake of brevity of description, the number of channels is reduced, and the arrangement form with total of eight channels (4 lines×two rows) is described.

In FIG. 14, a first row configured by a group of channels of ch1 to ch4 arranged in an oblique direction is used as a channel of a first beam group, and a second row configured by a group of remaining channels of ch5 to ch8 is used as a channel of a second beam group. The multiple-time scanning and exposure, in which the same scanning lines as the scanning lines exposed with the preceding first beam group (ch1 to ch4) are exposed by the subsequent second beam group (ch5 to ch8), are performed by the rotation of the drum 50 at a constant speed and the movement of the exposure head 30 in the sub-scanning direction at a constant speed.

In the case of such spiral exposure system, it is preferred to arrange the beams so that a gap of one pixel or more is provided between the first beam group (ch1 to ch4) and the second beam group (ch5 to ch8). FIG. 14 shows an example in which a gap of 4 pixels is provided between ch4 and ch5 in the sub-scanning direction. Such beam arrangement can be realized by suitably designing the distance (L1) between the rows of the optical fiber array units 300A and 300B provided in the two upper and lower stages as described with reference to FIG. 3.

By providing the gap between the first beam group and the second beam group in this way, it is possible to reduce the influence of heat (thermal interference) caused by the exposure with each of the beam groups.

Note that in the case of the exposure head 30 provided with the optical fiber array section 300 of 64 channels as described with reference to FIG. 1, a mode is adopted in which the first scanning exposure is performed with the beam group of the preceding first row (for example, the channel group belonging to the upper stage optical fiber array unit 300A in FIG. 3) by moving the exposure head 30 by the 32 channels in the sub-scanning direction during one rotation of the drum, and in which the second scanning exposure is performed with the beam group of the subsequent second row (for example, the channel group belonging to the lower stage optical fiber array unit 300B in FIG. 3).

Also in the case where the platemaking apparatus based on the spiral exposure system is used, it is possible to adopt the exposure scanning system of the first embodiment to the third embodiment as described above.

### Fifth Embodiment

### Example of Interlace Exposure (Twice Scanning)

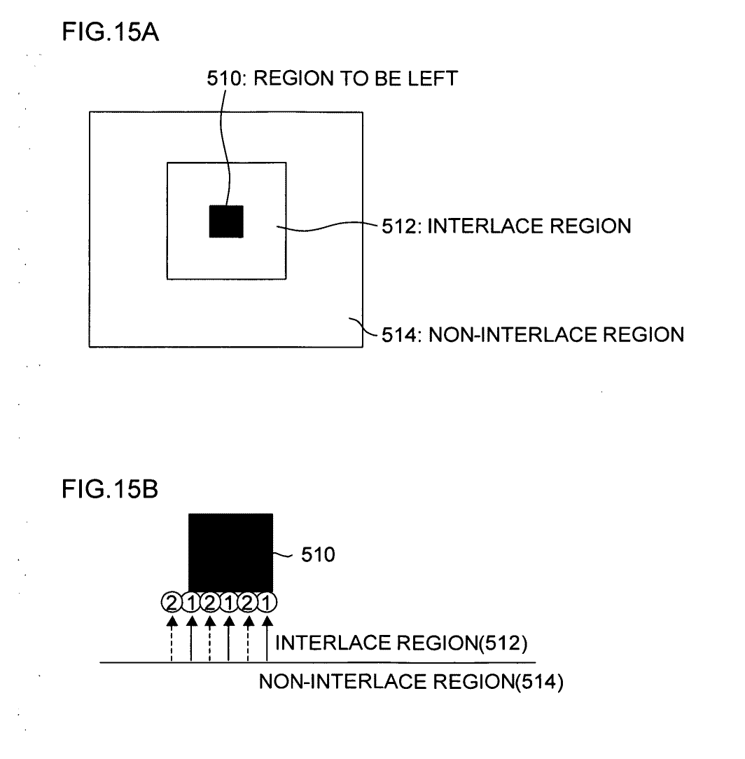

FIG. 15 are schematic views showing an outline of a multiple-time scanning exposure system according to a fifth embodiment. It is assumed that a rectangular region designated by reference numeral 510 in FIG. 15A is a region to be finally left on the surface of the plate material F. The peripheral region (reference numeral 512) near and including the region 510 is a region (hereinafter referred to as an “interlace region”) engraved by interlace scanning exposure in which the scanning lines are thinned out. A region (reference numeral 514) outside the interlace region 512 is a region (hereinafter referred to as a “non-interlace region”) engraved by non-interlace scanning exposure (normal scanning exposure in which the scanning lines are not thinned out).

In the enlarged view of FIG. 15B, the number “1” represents a position of a channel (position of a scanning line) of the beam group which is irradiated in the first scanning, and the number “2” represents a position of a channel (position of a scanning line) of the beam group which is irradiated in the second scanning.

In this way, the interlace region 512 is engraved by two scanning operations in which scanning lines are thinned out at one pixel intervals. Thereby, the region 510 to be left is formed.

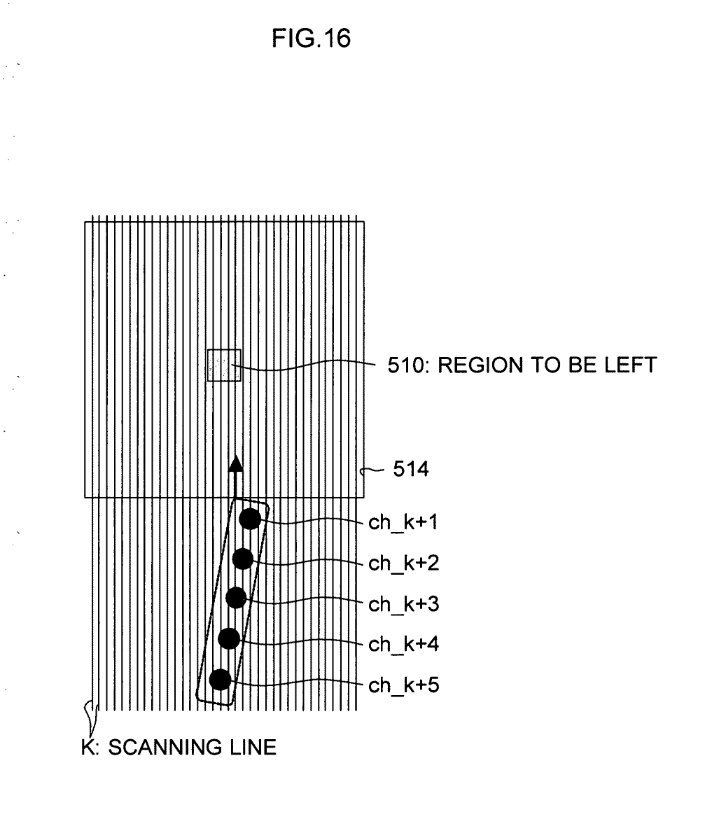

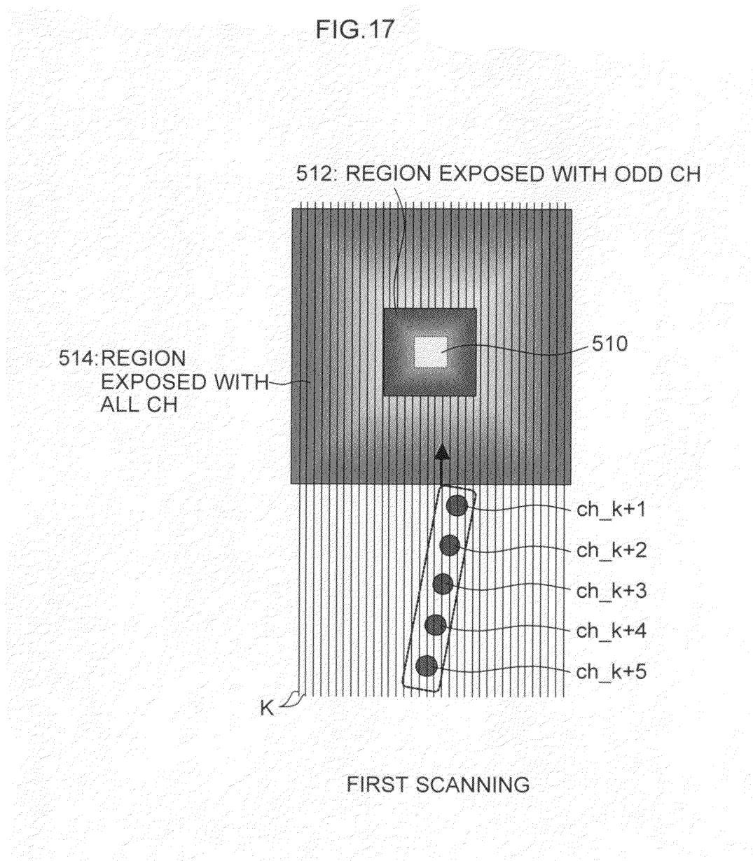

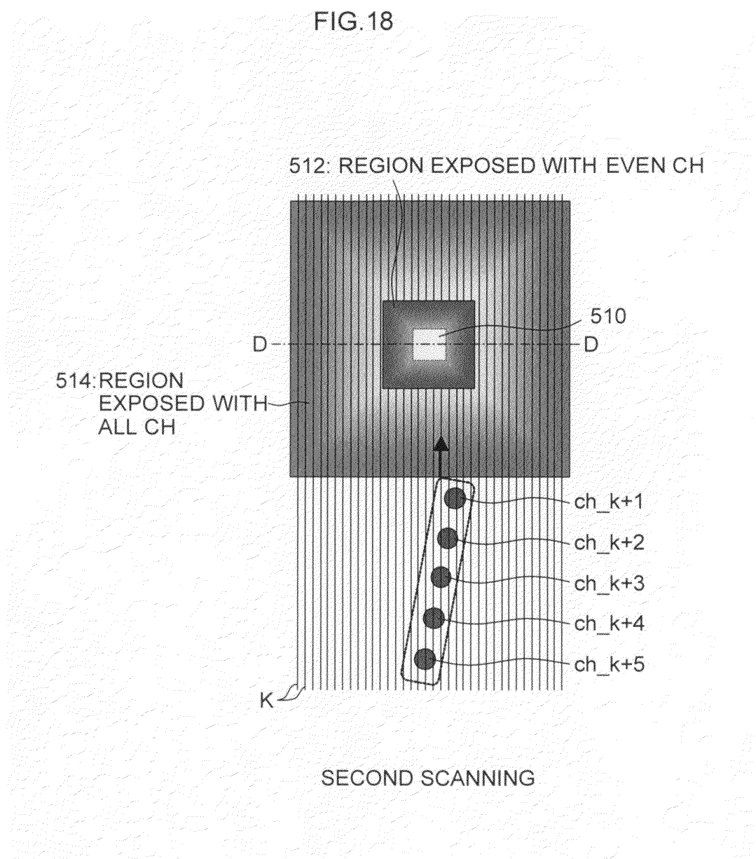

FIG. 16 is a schematic view showing a relationship between the region 510 to be left, the scanning lines, and the beam positions (channels). Note that in FIG. 16, for convenience of illustration, only the beam positions of five channels among total 64 channels are shown as ch_k+1 to ch_k+5. FIG. 17 shows a region exposed by the first scanning operation, and FIG. 18 shows a region exposed by the second scanning operation.

As shown in FIG. 17, in the first scanning operation, the non-interlace region 514 is exposed by all the channels so that rough engraving is performed. Further, the interlace region 512 is exposed by odd channels (for example, the beam group including ch_k+1, ch_k+3, and ch_k+5).

Thereafter, in the second scanning operation, the non-interlace region 514 is deeply engraved by being exposed by all the channels as shown in FIG. 18. Further, the interlace region 512 is exposed by even channels (for example, the beam group including ch_k+2 and ch_k+4).

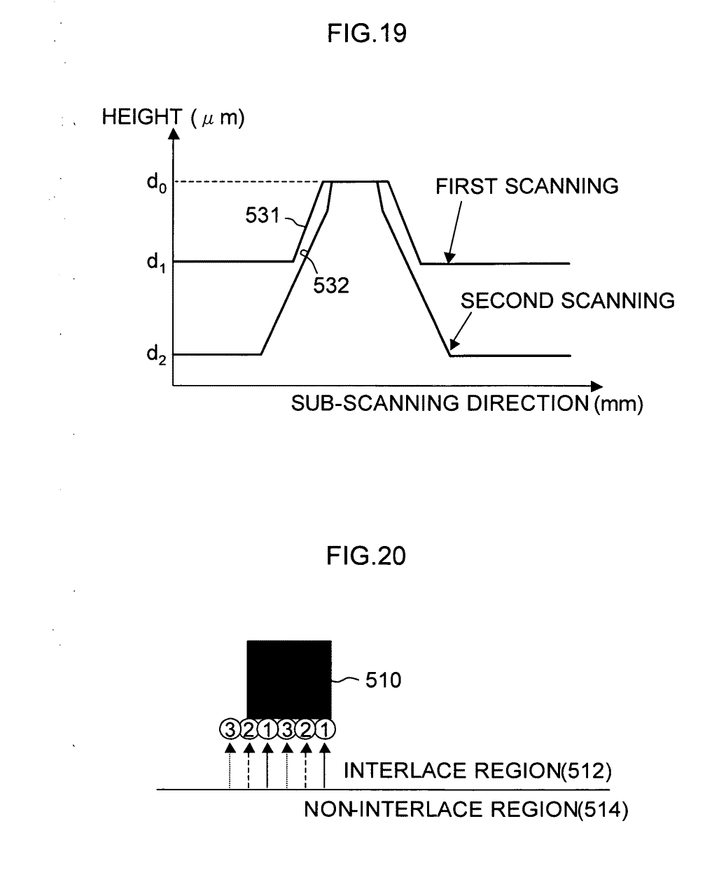

FIG. 19 shows a cross-sectional shape at the position (main scanning direction position) represented by the line D-D in FIG. 18. In FIG. 19, the abscissa represents the position (unit mm) in the sub-scanning direction, and the ordinate represents the height (unit μm). Note that the height of the ordinate corresponds to the depth engraved by the engraving and based on the position d₀ of the plate material surface which is finally left without being engraved.

As shown in FIG. 19, the non-interlace region 514 is engraved to the height d₁ (depth d₀ to d₁) by the first scanning operation, and the interlace region 512 is engraved into a substantially trapezoidal shape having an inclined section designated by reference numeral 531 in FIG. 19.

Then, the non-interlace region 514 is engraved to the height d₂ (depth d₀ to d₂) by the second scanning operation, and the surface shape and the inclined section of the interlace region 512 are further engraved as designated by reference numeral 532 in FIG. 19, so that the final target shape is obtained.

According to this mode, it is difficult to be influenced by the heat due to the adjacent beam, and hence it is possible to obtain a good target shape.

### Sixth Embodiment

### Example of Interlace Exposure (Three Times Scanning)

With reference to FIG. 15 to FIG. 19, an embodiment is described in which 5, an interlace region is exposed by two scanning operations with channels divided into two groups of odd channels and even channels, but the number of times of scanning is not limited to two. It is possible to adopt a mode in which the scanning is performed three times by thinning out the number of channels to ⅓.

FIG. 20 is a schematic view in the case of engraving the interlace region 512 by three scanning operations. In FIG. 20, the number “1” represents the channel positions of the beam group (positions of scanning lines) irradiated in the first scanning operation, the number “2” represents the channel positions of the beam group (positions of scanning lines) irradiated in the second scanning operation, and the number “3” represents the channel positions of the beam group (positions of scanning lines) irradiated in the third scanning operation.

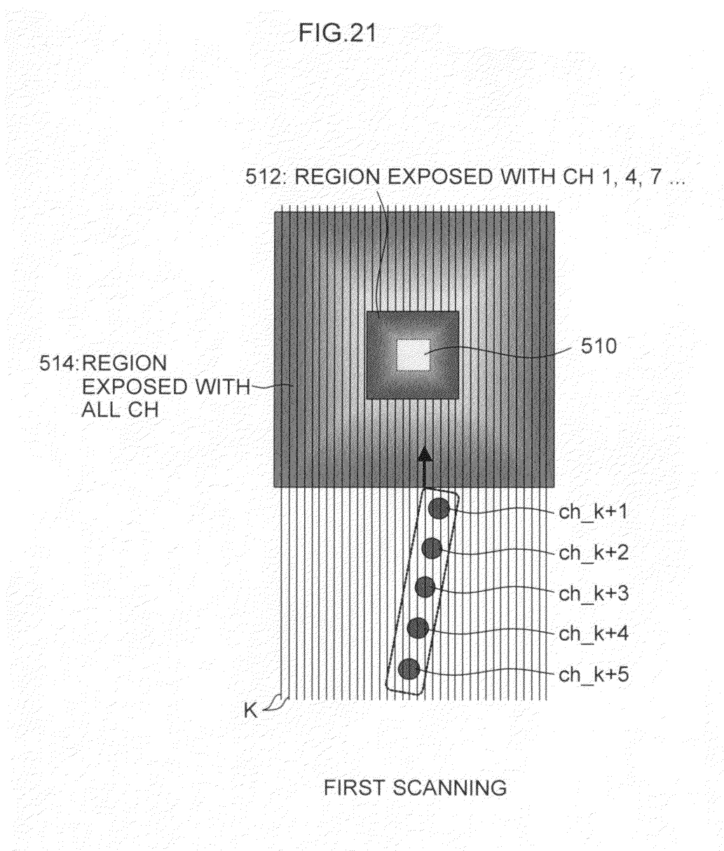

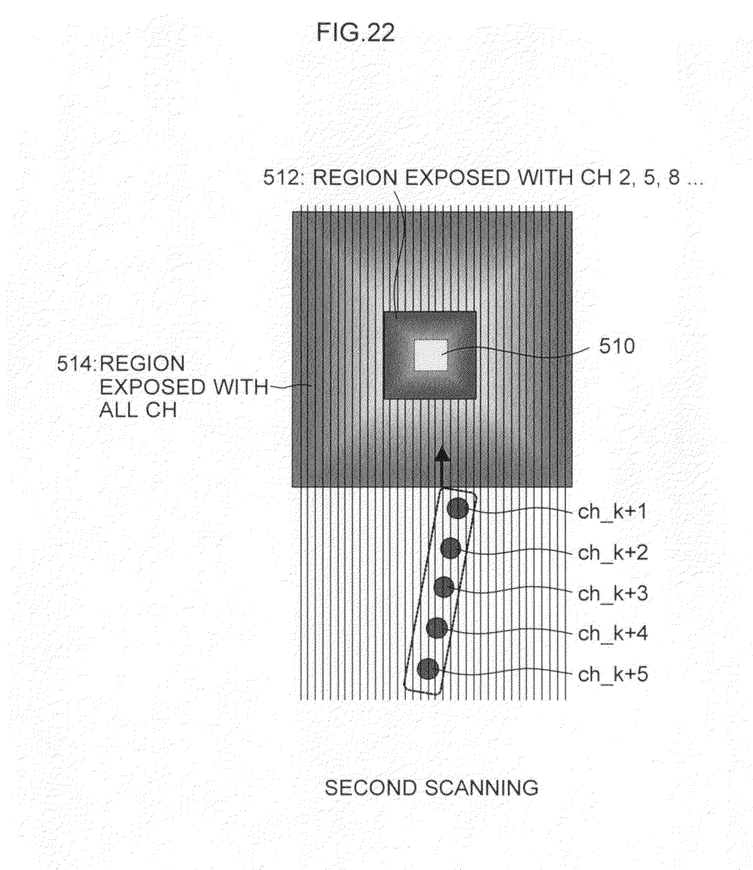

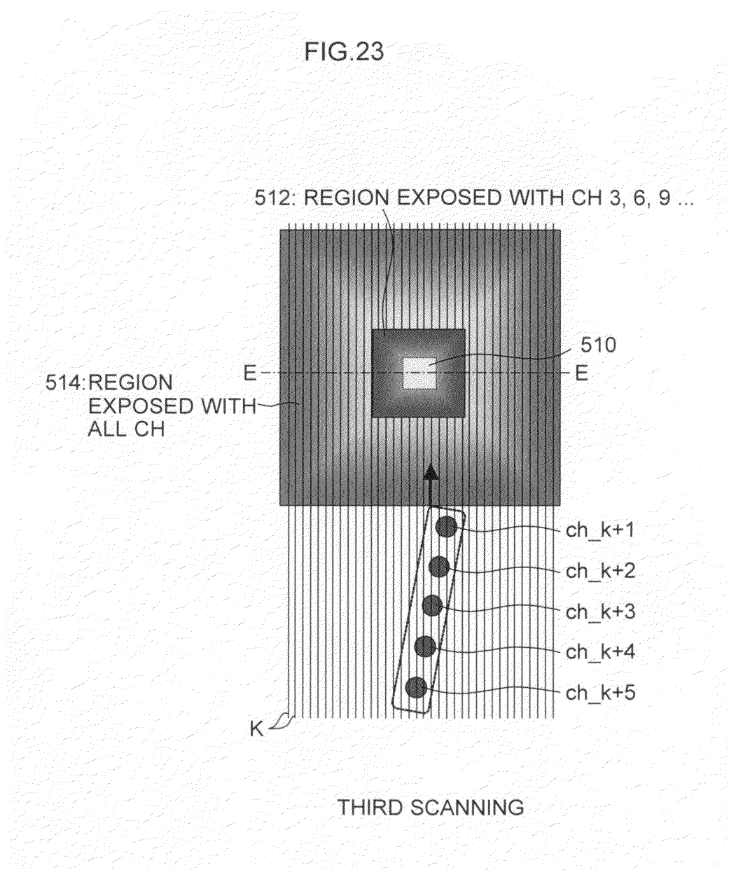

FIG. 21 shows the region exposed by the first scanning operation, and FIG. 22 and FIG. 23 show the regions exposed by the second and third scanning operations, respectively. In FIG. 21 to FIG. 23, the same or similar components to those in FIG. 15 to FIG. 19 are designated by the same reference numerals and characters, and the explanation thereof is omitted.

As shown in FIG. 21, in the first scanning operation, the interlace region 512 is exposed by the channels of the channel numbers 1, 4, 7 . . . .

Then, as shown in FIG. 22, in the second scanning operation, the interlace region 512 is exposed by the channels of the channel numbers 2, 5, 8 . . . .

Further, as shown in FIG. 23, in the third scanning operation, the interlace region 512 is exposed by the channels of the channel numbers 3, 6, 9 . . . .

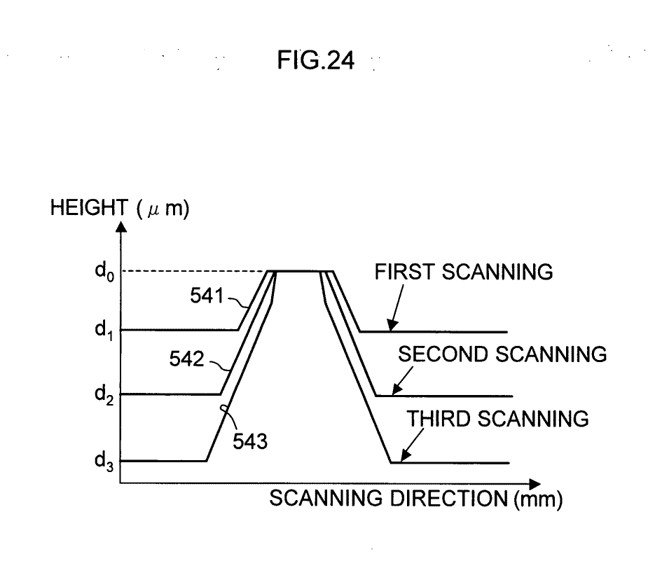

FIG. 24 shows a cross-sectional shape at the position (main scanning direction position) represented by the line E-E line in FIG. 23. In FIG. 24, the abscissa represents the position (unit mm) in the sub-scanning direction, and the ordinate represents the height (unit μm).

As shown in FIG. 24, the non-interlace region 514 is engraved to the height d₁ (depth d₀ to d₁) by the first scanning operation, and the interlace region 512 is engraved into a substantially trapezoidal shape having an inclined section designated by reference numeral 541 in FIG. 24.

Then, the non-interlace region 514 is engraved to the height d₂ (depth dₒ to d₂) by the second scanning operation, and the non-interlace region 514 is further engraved into a surface shape and an inclined section as designated by reference numeral 542 in FIG. 24.

Then, the non-interlace region 514 is engraved to the height d₃ (depth d₀ to d₃) by the third scanning operation, and the interlace region 512 is further engraved into a surface shape and an inclined section as designated by reference numeral 543 in FIG. 24, so that a final target shape is obtained.

According to this mode, it is more difficult to be influenced by the heat due to the adjacent beam, and hence it is possible to form a better target shape.

It is also possible to adopt methods, such as a four-time scanning method based on ¼ thinning and a five-time scanning method based on ⅕ thinning, similarly to the above described methods based on the two-time scanning (FIGS. 15 to 19) and the three-time scanning (FIGS. 20 to 24).

That is, a mode can be adopted in which all the channels are uniformly thinned out to 1/N in the sub-scanning direction so as to be divided into N channel groups (N is an integer of 2 or more), and in which the multiple-time scanning exposure is performed by changing the channel group used in each of N times of scanning operations. Note that the channel groups arranged along the sub-scanning direction are designated by channel numbers j (j=1, 2, 3 . . . ) from the end of the arrangement, and that the channel group can be grouped by residue numbers obtained by dividing the channel number j by N. As the interval between the adjacent beams is increased, it is possible to obtain a more significant effect of reducing the influence of the adjacent beam.

### Seventh Embodiment

### Another Mode of Interlace Exposure

In the fifth and sixth embodiments described above, the non-interlace beam arrangement is configured by the optical fiber array light source. With this arrangement, the non-interlace region 514 (corresponding to the “second region”) of the recording medium (plate material F) is subjected to the non-interlace exposure, while the interlace region 512 (corresponding to the “first region”) is subjected to pseudo-interlace exposure with the thinned-out beam group. However, it is also possible to adopt an embodiment in which the beam arrangement itself is formed by the interlace arrangement (for example, at every other scanning line), and in which the first region (interlace region 512) is exposed by the pseudo-interlace exposure with a beam interval further increased by this interlace arrangement.

That is, in the case where the interval between the scanning lines in the sub-scanning direction is set as PK₀, where the interval (in the sub-scanning direction) between adjacent beams of the beam group which exposes the planar shape region to be finally left on the surface of the recording medium and the “first region” corresponding to the region around the planar shape region is set as BP₁, and where the interval (in the sub-scanning direction) between adjacent beams of the beam group which exposes the “second region” outside the first region is set as BP₂, the design of the beam arrangement and the control of the channels used in exposing the respective regions are performed so that the relationship PK₀≦BP₂<BP₁ is established.

For example, interlace arrangement with every N scanning lines (N is an integer of two or more) is adopted as the beam arrangement, and the second region is subjected to the interlace exposure scanning based on the interlace arrangement (BP2=N×PK₀). Further, the first region is subjected to interlace exposure scanning with beam groups formed by further uniformly thinning out the interlace arrangement to 1/M (M is an integer of two or more, BP₁=M×BP₂).

With such embodiment, it is also possible to form a good target shape similarly to the fifth and sixth embodiments.

### COMBINATION OF EMBODIMENTS

The methods of the first to seventh embodiments described above can be suitably combined.

### Combination Example 1

For example, there is a mode in which the fine engraving process in the first embodiment is performed by being divided into the forming process of edge section in the sub-scanning direction and the forming process of the edge section in the main scanning direction as in the second embodiment.

### Combination Example 2

There is a mode in which after the rough engraving process in the first embodiment, the contour line engraving process and the inclined section forming process in the third embodiment are performed. Alternatively, there is a mode in which after the contour line engraving process in the third embodiment, the rough engraving process and the fine engraving process in the first embodiment are performed.

### Combination Example 3

A mode can be adopted in which the interlace exposure described in the fifth to seventh embodiments is used as the fine engraving process in the first embodiment.

### Combination Example 4

A mode can be adopted in which the interlace exposure described in the fifth to seventh embodiments is used as the forming process of the edges in the respective directions of the sub-scanning direction and the main scanning direction in the second embodiment.

### Combination Example 5

A mode can be adopted in which the interlace exposure described in the fifth to seventh embodiments is used as at least one of the contour line engraving process and the inclined section forming process in the third embodiment.

Further, various combination modes can be adopted other than the above described combination examples 1 to 5, and any of the modes can be realized by any one of the sub-scanning direction intermittent feeding exposure system and the spiral exposure system.

### <Manufacturing Process of Flexographic Plate>

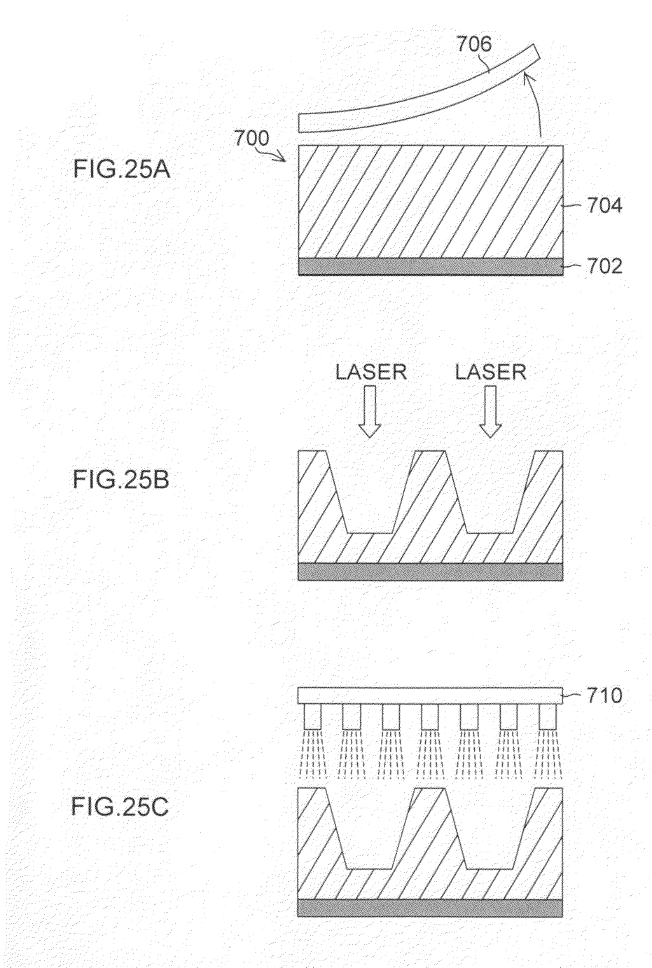

FIGS. 25A to 25C show an outline of a plate making process. A raw plate 700 used in the platemaking based on the laser engraving has an engraving layer 704 (a rubber layer or a resin layer) on a substrate 702, and has a protection cover film 706 which is stuck on the engraving layer 704. At the time of platemaking processing, as shown in FIG. 25A, the cover film 706 is peeled off so that the engraving layer 704 is exposed. Then, a part of the engraving layer 704 is removed by irradiating laser light beams onto the engraving layer 704 so that a desired three-dimensional shape is formed (see FIG. 24B). The specific laser engraving method has been described with reference to FIGS. 1 to 24. Note that dust generated during the laser engraving is sucked and recovered by a suction apparatus (not shown).

After the engraving process is completed, water washing is performed by a washing apparatus 710 as shown in FIG. 25C (washing process), and then a flexographic plate is completed by being subjected to a drying process (not shown).

The platemaking method, by which a plate itself is directly engraved with a laser beam in this way, is referred to as a direct engraving method. A platemaking apparatus, to which the multi-beam exposure scanning apparatus according to the present embodiment is applied, can be realized at a lower cost than a laser engraving machine using a CO₂ laser. Further, processing speed can be improved by using the multi-beam exposure system, so that the productivity of the printing plate can be improved.

### OTHER APPLICATIONS

The present invention is not limited to manufacture of flexographic plates, and the present invention can also be applied to manufacture of the other convex printing plates or concave printing plates. Further, the present invention is not limited to manufacture of printing plates, and the present invention can also be applied to a drawing recording apparatus and an engraving apparatus for various applications.

### APPENDIX

As grasped from the description about the embodiments described above in detail, this specification includes disclosure of various technical concepts including inventions as will be described below.

In the following inventions, “an object” may be a recording medium.

(Invention 1): A multi-beam exposure scanning method for exposing and scanning same scanning lines a plurality of times by simultaneously irradiating an object with a plurality of light beams to engrave a surface of the object, the method characterized by including: a first exposure scanning process of forming a first shape, which defines an outline shape of a target planar shape to be left on an exposure surface of the object and an inclined section around the target planar shape, with a first beam group; and a second exposure scanning process of forming a second shape, which defines a final shape of the target planar shape and the inclined section around the target planar shape, by exposing and scanning with a second beam group the same scanning lines as those exposed and scanned in the first exposure scanning process.

According to the present invention, the rough engraving is performed with the first beam group whose beams are irradiated so that relatively large energy is irradiated onto the recording medium (first exposure scanning process), and thereafter the final target shape is precisely engraved by the second beam group whose beams are irradiated so that small energy is irradiated onto the recording medium (second exposure scanning process). Thereby, it is possible to reduce the influence of heat on the surface section to be left. As a result, it is possible to improve the precision of the final shape, and also possible to increase the steepness of the inclined section (slope).

(Invention 2): A multi-beam exposure scanning method for exposing and scanning same scanning lines a plurality of times by simultaneously irradiating an object with a plurality of light beams to engrave a surface of the object, the method characterized by including: a first exposure scanning process of forming a first edge section along one direction of a first direction and a second direction different from the first direction with a first beam group, among edge sections of a planar shape to be left on the exposure surface of the object; and a second exposure scanning process of forming, after the first exposure scanning process, a second edge section along the other direction different from the one direction of the first direction and the second direction with a second beam group.

According to the present invention, it is possible to reduce the influence of heat in the corner section at which both the edge sections intersect each other, in comparison with the case where the first edge section along the first direction and the second edge section along the second direction are formed at once (simultaneously). Thus, it is possible to improve the precision of the shape at the corner section.

For example, there is a mode in which one of the first direction and the second direction is set as the main scanning direction and in which the other direction is set as the sub-scanning direction. However, from a viewpoint of reducing the thermal effect at the corner section, the first direction and the second direction may not necessarily be perpendicular to each other.

(Invention 3): A multi-beam exposure scanning method for exposing and scanning same scanning lines a plurality of times by simultaneously irradiating an object with a plurality of light beams to engrave a surface of the object, the method characterized by including: a first exposure scanning process of drawing and engraving, with a first beam group, a line drawing of an edge section of a target planar shape to be left on the exposure surface of the object so that only the edge section is formed; and a second exposure scanning process of forming, after the first exposure scanning process, an inclined section around the target planar shape by exposing and scanning the outside region of the line drawing with a second beam group.

According to the present invention, the contour line of the target planar shape is precisely drawn and engraved with the first beam group whose beams are irradiated so that relatively small energy is irradiated onto the recording medium (first exposure scanning process), and thereafter the region outside the contour line is engraved with the second beam group whose beams are irradiated so that relatively large energy is irradiated onto the recording medium (second exposure scanning process). Thereby, it is possible to perform processing without excessively heating the surface section to be left, and hence it is possible to highly precisely form the desired shape.

(Invention 4): A multi-beam exposure scanning method for exposing and scanning same scanning lines a plurality of times by simultaneously irradiating an object with a plurality of light beams to engrave a surface of the object, the method characterized in that when a target planar shape region to be left on the exposure surface of the recording medium and a peripheral region of the target planar shape region are set as a first region, and the region outside of the first region is set as a second region, the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and the second region is subjected to non-interlace exposure which performs engraving with a beam group having an adjacent beam interval equal to the scanning line interval.

According to the present invention, in the vicinity (first region) of the surface shape to be left, a gap is provided between adjacent beams by performing the interlace exposure, so as to reduce the influence of heat (thermal interference) due to the adjacent beams. Thereby, it is possible to perform precise engraving while reducing the accumulation of heat. Further, in the second region further outside the first region, rough engraving, deep engraving, and the like, can be performed by the non-interlace exposure.

(Invention 5): The multi-beam exposure scanning method according to invention 1, characterized by further including: a third exposure scanning process of forming a first edge section along one direction of a first direction and a second direction different from the first direction with a third beam group, among edge sections of the target planar shape to be left on the exposure surface of the object; and a fourth exposure scanning process of forming, after the third exposure scanning process, a second edge section along the other direction different from the one direction of the first direction and the second direction with a fourth beam group.

For example, a mode can be adopted in which the third exposure scanning process and the fourth exposure scanning process are performed in the second exposure scanning process.

(Invention 6): The multi-beam exposure scanning method according to one of inventions 1, 2, and 5, characterized by further including: a fifth exposure scanning process of drawing and engraving, with a fifth beam group, a line drawing of an edge section of the target planar shape to be left on the exposure surface of the object so that only the edge section is formed; and a sixth exposure scanning process of exposing and scanning, after the fifth exposure scanning process, the outside region of the line drawing with a sixth beam group to form an inclined section around the target planar shape.

For example, a mode can be adopted in which after the line drawing of the edge section is drawn and engraved by the fifth exposure scanning process, the first exposure scanning process and the second exposure scanning process in invention 1 are performed.

(Invention 7): The multi-beam exposure scanning method according to one of inventions 1, 2, 3, 5, and 6, characterized in that when the target planar shape region to be left on the exposure surface of the object and the peripheral region of the target planar shape region are set as a first region, and the region outside the first region is set as a second region, in that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and in that the second region is subjected to non-interlace exposure which performs engraving with a beam group having an adjacent beam interval equal to the scanning line interval.

For example, there is a mode in which the interlace exposure is performed in the second exposure scanning process in invention 1.

(Invention 8): The multi-beam exposure scanning method according to one of inventions 1 to 7, characterized in that the object is held on an outer peripheral surface of a drum, and in that an exposure head, which irradiates the plurality of light beams onto the surface of the object rotated together with the drum, is configured to be freely moved in an axial direction of the drum, so that exposure scanning is performed in a state where the sub-scan feeding in parallel with the axial direction of the drum is set as intermittent feeding.

The intermittent feeding system according to the mode of the present invention is effective when the rotation speed of the drum is relatively low.

(Invention 9): The multi-beam exposure scanning method according to one of inventions 1 to 7, characterized in that the object is held on the outer peripheral surface of a drum, and in that an exposure head, which irradiates the plurality of light beams onto the surface of the recording medium rotated together with the drum, is configured to be freely moved in an axial direction of the drum, so that spiral exposure scanning is performed in a state where the sub-scan feeding in parallel with the axial direction of the drum is set as continuous feeding.

The spiral exposure system according to the mode of the present invention is effective when the rotation speed of the drum is relatively high.

(Invention 10): The multi-beam exposure scanning method according to invention 9, characterized by using an exposure head in which the beam group arrangement is set so that a gap including at least one pixel is provided between the preceding first beam group in exposing the same scanning lines the plurality of times, and the subsequent second beam group.

In the exposure head used in the spiral exposure, it is possible to reduce the thermal interference between the simultaneously irradiated beam groups by providing the gap between the first beam group and the second beam group.

(Invention 11): A multi-beam exposure scanning apparatus comprising: an exposure head configured to engrave a surface of an object by simultaneously irradiating the object with a plurality of light beams; a scanning device which moves the object and the exposure head relative to each other to expose and scan same scanning lines a plurality of times; a first exposure scanning control device which effects a first exposure scanning operation to form a first shape, which defines an outline shape of a target planar shape to be left on the exposure surface of the object and an inclined section around the target planar shape, with a first beam group; and a second exposure scanning control device which effects a second exposure scanning operation to form a second shape, which is a final shape formed by the target planar shape and the inclined section around the target planar shape, by exposing and scanning with a second beam group the same scanning lines as those exposed and scanned in the first exposure scanning operation.

According to the present invention, the influence of the heat on the surface section to be left can be reduced. Thereby, it is possible to improve the precision of the target surface shape and also possible to increase the steepness of the inclined section (slope).

Note that both of the first exposure scanning control device and the second exposure scanning control device are configured to control the exposure head and the scanning device, and hence can be physically realized by a common control circuit.

(Invention 12): A multi-beam exposure scanning apparatus comprising: an exposure head configured to engrave the surface of a recording medium by simultaneously irradiating a plurality of light beams to the recording medium; a scanning device configured to which moves the object and the exposure head relative to each other to expose and scan same scanning lines a plurality of times; a first exposure scanning control device which effects a first exposure scanning operation to form a first edge section along one direction of a first direction and a second direction different from the first direction with a first beam group, among edge sections of a target planar shape to be left on the exposure surface of the object; and a second exposure scanning control device which effects, after the first exposure scanning operation, a second exposure scanning operation to form a second edge section along the other direction different from the one direction of the first direction and the second direction with a second beam group.

According to the present invention, the shape of the corner section, at which the first edge section along the first direction intersects the second edge section along the second direction, can be engraved with good precision.

(Invention 13): A multi-beam exposure scanning apparatus comprising: an exposure head configured to engrave a surface of an object by simultaneously irradiating the object with a plurality of light beams; a scanning device which moves the object and the exposure head relative to each other to expose and scan same scanning lines a plurality of times; a first exposure scanning control device which effects a first exposure scanning operation to draw and engrave, with a first beam group, a line drawing of an edge section of a target planar shape to be left on the exposure surface of the object so that only the edge section is formed; and a second exposure scanning control device which effects, after the first exposure scanning operation, a second exposure scanning operation to form an inclined section around the target planar shape by exposing and scanning the outside region of the line drawing with a second beam group.

According to the present invention, it is possible to suppress the influence of heat on the vicinity of the surface section to be left, and hence it is possible to form a desired surface shape with high precision.

(Invention 14): A multi-beam exposure scanning apparatus comprising: an exposure head configured to engrave the surface of an object by simultaneously irradiating the object with a plurality of light beams; a scanning device which moves the object and the exposure head relative to each other to expose and scan same scanning lines a plurality of times; and an exposure scanning control device which controls the exposure head and the scanning device in such a manner that a target planar shape region to be left on an exposure surface of the object and a peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

According to the present invention, the interlace exposure with the gap provided between the adjacent beams is performed when the vicinity (first region) of the surface shape to be left is engraved. Thus, the influence of heat due to the adjacent beam is reduced, so that the highly precise engraving can be performed.

(Invention 15): The multi-beam exposure scanning apparatus according to invention 11, further comprising: a third exposure scanning control device which effects a third exposure scanning operation to form a first edge section along one direction of a first direction and a second direction different from the first direction with a third beam group, among edge sections of the target planar shape to be left on the exposure surface of the object; and a fourth exposure scanning control device which effects, after the third exposure scanning operation, a fourth exposure scanning operation to form a second edge section along the other direction different from the one direction of the first direction and the second direction with a fourth beam group.

(Invention 16): The multi-beam exposure scanning apparatus according to one of inventions 11, 12, and 15, further comprising: a fifth exposure scanning control device which effects a fifth exposure scanning operation to draw and engrave, with a fifth beam group, a line drawing of an edge section of the target planar shape to be left on the exposure surface of the object so that only the edge section is formed; and a sixth exposure scanning control device which effects, after the fifth exposure scanning operation, a sixth exposure scanning operation to expose and scan the outside region of the line drawing with a sixth beam group to form an inclined section around the target planar shape.

Note that the third exposure scanning control device and the fourth exposure scanning control device in invention 15, and the fifth exposure scanning control device and the sixth exposure scanning control device in invention 16 are all configured to control the exposure head and the scanning device, and hence can be physically realized by a common control circuit together with the first exposure scanning control device and the second exposure scanning control device.

(Invention 17): The multi-beam exposure scanning apparatus according to one of inventions 11, 12, 13, 15, and 16, further comprising an exposure scanning control device which controls the exposure head and the scanning device in such a manner that the target planar shape region to be left on the exposure surface of the object and the peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

Note that the third exposure scanning control device and the fourth exposure scanning control device in invention 15, and the fifth exposure scanning control device and the sixth exposure scanning control device in invention 16, and the exposure scanning control device in invention 17 are all configured to control the exposure head and the scanning device, and hence can be physically realized by a common control circuit together with the first exposure scanning control device and the second exposure scanning control device.

(Invention 18): the multi-beam exposure scanning apparatus according to one of inventions 11 to 17, characterized in that the scanning device includes a drum which is rotated while holding the object on the outer peripheral surface thereof, and a head moving device which moves the exposure head along an axial direction of the drum, and exposure scanning is performed in a state where the sub-scan feeding in parallel with the axial direction of the drum is set as intermittent feeding by the head moving device.

In the apparatus configuration in which the scanning in the main scanning direction is performed by the rotation of the drum, and in which the scanning in the sub-scanning direction is performed by the movement of the exposure head in the axial direction of the drum, it is possible to adopt a mode in which the sub-scan feeding is set as intermittent feeding.

(Invention 19): The multi-beam exposure scanning apparatus according to one of inventions 11 to 17, characterized in that the scanning device includes a drum which is rotated by holding the recording medium on the outer peripheral surface thereof, and a head moving device which moves the exposure head along an axial direction of the drum, and in that spiral exposure scanning is performed in the state where the sub-scan feeding in parallel with the axial direction of the drum is set as continuous feeding.

In the apparatus configuration in which the scanning in the main scanning direction is performed by the rotation of the drum, and in which the scanning in the sub-scanning direction is performed by the movement of the exposure head in the axial direction of the drum, it is possible to adopt a mode in which the sub-scan feeding is set as the continuous feeding. For example, spiral scanning lines along the peripheral surface of the drum can be exposed by feeding the exposure head in the sub-scanning direction at a constant speed while the drum is rotated at a constant speed. Note that the feed rate in the sub-scanning direction may be changed in dependence upon the array form of the beam group.

(Invention 20): The multi-beam exposure scanning apparatus according to invention 19, characterized in that the exposure head has a beam group arrangement which is set so that a gap including at least one pixel is provided between the preceding first beam group in exposing the same scanning lines a plurality of times, and the subsequent second beam group.

According to this mode, it is possible to suppress the thermal interference between the beam groups.

(Invention 21): A manufacturing method of a printing plate characterized by comprising: engraving the surface of a plate material corresponding to the object by the multi-beam exposure scanning method according to any one of inventions 1 to 10 to obtain the printing plate.

According to the present invention, a printing plate can be manufactured at high speed and with high precision, so that the productivity can be improved and a cost reduction can be realized.

### DESCRIPTION OF SYMBOLS

10 . . . Laser recording apparatus, 11 . . . Platemaking apparatus, 20 . . . Light source unit, 21A, 21B . . . Semiconductor laser, 22A, 22B, 70A, 70B . . . Optical fiber, 30 . . . Exposure head, 40 . . . Exposure head movement section, 50 . . . Drum, 80 . . . Control circuit, 300 . . . Optical fiber array section, 512 . . . Interlace region, 514 . . . Non-interlace region, F . . . Plate material, K . . . Scanning line

1. A multi-beam exposure scanning method for exposing and scanning same scanning lines a plurality of times by simultaneously irradiating an object with a plurality of light beams to engrave a surface of the object, the method comprising:
a first exposure scanning process of forming a first shape, which defines an outline shape of a target planar shape to be left on an exposure surface of the object and an inclined section around the target planar shape, with a first beam group; and
a second exposure scanning process of forming a second shape, which defines a final shape of the target planar shape and the inclined section around the target planar shape, by exposing and scanning with a second beam group the same scanning lines as the scanning lines exposed and scanned in the first exposure scanning process.

2-21. (canceled)

22. The multi-beam exposure scanning method according to claim 1, further comprising:
a third exposure scanning process of forming a first edge section along one direction of a first direction and a second direction different from the first direction with a third beam group, among edge sections of the target planar shape to be left on the exposure surface of the object; and
a fourth exposure scanning process of forming, after the third exposure scanning process, a second edge section along the other direction different from the one direction of the first direction and the second direction with a fourth beam group.

23. The multi-beam exposure scanning method according to claim 1, further comprising:
a fifth exposure scanning process of drawing and engraving, with a fifth beam group, a line drawing of an edge section of the target planar shape to be left on the exposure surface of the object so that only the edge section is formed; and
a sixth exposure scanning process of exposing and scanning, after the fifth exposure scanning process, the outside region of the line drawing with a sixth beam group to form an inclined section around the target planar shape.

24. The multi-beam exposure scanning method according to claim 1, characterized in that
when the target planar shape region to be left on the exposure surface of the object and the peripheral region of the target planar shape region are set as a first region, and the region outside the first region is set as a second region,
the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and
the second region is subjected to non-interlace exposure which performs engraving with a beam group having an adjacent beam interval equal to the scanning line interval.

25. The multi-beam exposure scanning method according to claim 1, characterized in that
the object is held on an outer peripheral surface of a drum, and
an exposure head, which irradiates the plurality of light beams onto the surface of the object rotated together with the drum, is configured to be freely moved in an axial direction of the drum, so that exposure scanning is performed in a state where the sub-scan feeding in parallel with the axial direction of the drum is set as intermittent feeding.

26. The multi-beam exposure scanning method according to claim 1, characterized in that
the object is held on an outer peripheral surface of a drum, and
an exposure head, which irradiates the plurality of light beams onto the surface of the object rotated together with the drum, is configured to be freely moved in an axial direction of the drum, so that spiral exposure scanning is performed in a state where the sub-scan feeding in parallel with the axial direction of the drum is set as continuous feeding.

27. The multi-beam exposure scanning method according to claim 26, characterized
by using an exposure head in which the beam group arrangement is set so that a gap including at least one pixel is provided between the preceding first beam group in exposing the same scanning lines a plurality of times, and the subsequent second beam group.

28. A multi-beam exposure scanning method for exposing and scanning same scanning lines a plurality of times by simultaneously irradiating an object with a plurality of light beams to engrave a surface of the object, the method comprising:
a first exposure scanning process of forming a first edge section along one direction of a first direction and a second direction different from the first direction with a first beam group, among edge sections of a target planar shape to be left on the exposure surface of the object; and
a second exposure scanning process of forming, after the first exposure scanning process, a second edge section along the other direction different from the one direction of the first direction and the second direction with a second beam group.

29. The multi-beam exposure scanning method according to claim 28, further comprising:
a fifth exposure scanning process of drawing and engraving, with a fifth beam group, a line drawing of an edge section of the target planar shape to be left on the exposure surface of the object so that only the edge section is formed; and
a sixth exposure scanning process of exposing and scanning, after the fifth exposure scanning process, the outside region of the line drawing with a sixth beam group to form an inclined section around the target planar shape.

30. The multi-beam exposure scanning method according to claim 28, characterized in that
when the target planar shape region to be left on the exposure surface of the object and the peripheral region of the target planar shape region are set as a first region, and the region outside the first region is set as a second region,
the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and
the second region is subjected to non-interlace exposure which performs engraving with a beam group having an adjacent beam interval equal to the scanning line interval.

31. The multi-beam exposure scanning method according to claim 28, characterized in that
the object is held on an outer peripheral surface of a drum, and
an exposure head, which irradiates the plurality of light beams onto the surface of the object rotated together with the drum, is configured to be freely moved in an axial direction of the drum, so that exposure scanning is performed in a state where the sub-scan feeding in parallel with the axial direction of the drum is set as intermittent feeding.

32. The multi-beam exposure scanning method according to claim 28, characterized in that
the object is held on an outer peripheral surface of a drum, and
an exposure head, which irradiates the plurality of light beams onto the surface of the object rotated together with the drum, is configured to be freely moved in an axial direction of the drum, so that spiral exposure scanning is performed in a state where the sub-scan feeding in parallel with the axial direction of the drum is set as continuous feeding.

33. The multi-beam exposure scanning method according to claim 32, characterized
by using an exposure head in which the beam group arrangement is set so that a gap including at least one pixel is provided between the preceding first beam group in exposing the same scanning lines a plurality of times, and the subsequent second beam group.

34. A multi-beam exposure scanning method for exposing and scanning same scanning lines a plurality of times by simultaneously irradiating an object with a plurality of light beams to engrave a surface of the object, the method comprising:
a first exposure scanning process of drawing and engraving, with a first beam group, a line drawing of an edge section of a target planar shape to be left on the exposure surface of the object so that only the edge section is formed; and
a second exposure scanning process of forming, after the first exposure scanning process, an inclined section around the target planar shape by exposing and scanning an outside region of the line drawing with a second beam group.

35. The multi-beam exposure scanning method according to claim 34, characterized in that
when the target planar shape region to be left on the exposure surface of the object and the peripheral region of the target planar shape region are set as a first region, and the region outside the first region is set as a second region,
the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and
the second region is subjected to non-interlace exposure which performs engraving with a beam group having an adjacent beam interval equal to the scanning line interval.

36. The multi-beam exposure scanning method according to claim 34, characterized in that
the object is held on an outer peripheral surface of a drum, and
an exposure head, which irradiates the plurality of light beams onto the surface of the object rotated together with the drum, is configured to be freely moved in an axial direction of the drum, so that exposure scanning is performed in a state where the sub-scan feeding in parallel with the axial direction of the drum is set as intermittent feeding.

37. The multi-beam exposure scanning method according to claim 34, characterized in that
the object is held on an outer peripheral surface of a drum, and
an exposure head, which irradiates the plurality of light beams onto the surface of the object rotated together with the drum, is configured to be freely moved in an axial direction of the drum, so that spiral exposure scanning is performed in a state where the sub-scan feeding in parallel with the axial direction of the drum is set as continuous feeding.

38. The multi-beam exposure scanning method according to claim 37, characterized
by using an exposure head in which the beam group arrangement is set so that a gap including at least one pixel is provided between the preceding first beam group in exposing the same scanning lines a plurality of times, and the subsequent second beam group.

39. A multi-beam exposure scanning method for exposing and scanning same scanning lines a plurality of times by simultaneously irradiating an object with a plurality of light beams to engrave a surface of the object, characterized in that
when a target planar shape region to be left on an exposure surface of the object and a peripheral region of the target planar shape region are set as a first region, and the region outside of the first region is set as a second region,
the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and
the second region is subjected to non-interlace exposure which performs engraving with a beam group having an adjacent beam interval equal to the scanning line interval.

40. The multi-beam exposure scanning method according to claim 39, characterized in that
the object is held on an outer peripheral surface of a drum, and
an exposure head, which irradiates the plurality of light beams onto the surface of the object rotated together with the drum, is configured to be freely moved in an axial direction of the drum, so that exposure scanning is performed in a state where the sub-scan feeding in parallel with the axial direction of the drum is set as intermittent feeding.

41. The multi-beam exposure scanning method according to claim 39, characterized in that
the object is held on an outer peripheral surface of a drum, and
an exposure head, which irradiates the plurality of light beams onto the surface of the object rotated together with the drum, is configured to be freely moved in an axial direction of the drum, so that spiral exposure scanning is performed in a state where the sub-scan feeding in parallel with the axial direction of the drum is set as continuous feeding.

42. The multi-beam exposure scanning method according to claim 41, characterized
by using an exposure head in which the beam group arrangement is set so that a gap including at least one pixel is provided between the preceding first beam group in exposing the same scanning lines a plurality of times, and the subsequent second beam group.

43. A multi-beam exposure scanning apparatus comprising:
an exposure head configured to engrave a surface of an object by simultaneously irradiating the object with a plurality of light beams;
a scanning device which moves the object and the exposure head relative to each other to expose and scan same scanning lines a plurality of times;
a first exposure scanning control device which effects a first exposure scanning operation to form a first shape, which is an outline shape formed by a target planar shape to be left on the exposure surface of the object and an inclined section around the target planar shape, with a first beam group; and
a second exposure scanning control device which effects a second exposure scanning operation to form a second shape, which defines a final shape of the target planar shape and the inclined section around the target planar shape, by exposing and scanning with a second beam group the same scanning lines as the scanning lines exposed and scanned in the first exposure scanning operation.

44. The multi-beam exposure scanning apparatus according to claim 43, further comprising:
a third exposure scanning control device which effects a third exposure scanning operation to form a first edge section along one direction of a first direction and a second direction different from the first direction with a third beam group, among edge sections of the planar shape to be left on the exposure surface of the object; and
a fourth exposure scanning control device which effects, after the third exposure scanning operation, a fourth exposure scanning operation to form a second edge section along the other direction different from the one direction of the first direction and the second direction with a fourth beam group.

45. The multi-beam exposure scanning apparatus according to claim 43, further comprising:
a fifth exposure scanning control device which effects a fifth exposure scanning operation to draw and engrave, with a fifth beam group, a line drawing of an edge section of the target planar shape to be left on the exposure surface of the object so that only the edge section is formed; and
a sixth exposure scanning control device which effects, after the fifth exposure scanning operation, a sixth exposure scanning operation to expose and scan the outside region of the line drawing with a sixth beam group to form an inclined section around the target planar shape.

46. The multi-beam exposure scanning apparatus according to claim 43, further comprising
an exposure scanning control device which controls the exposure head and the scanning device in such a manner that the target planar shape region to be left on the exposure surface of the object and the peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

47. The multi-beam exposure scanning apparatus according to claim 43, characterized in that
the scanning device includes a drum which is rotated while holding the object on the outer peripheral surface thereof, and a head moving device which moves the exposure head along an axial direction of the drum, and
exposure scanning is performed in a state where the sub-scan feeding in parallel with the axial direction of the drum is set as intermittent feeding by the head moving device.

48. The multi-beam exposure scanning apparatus according to claim 43, characterized in that
the scanning device includes a drum which is rotated while holding the object on the outer peripheral surface thereof, and a head moving device which moves the exposure head along an axial direction of the drum, and
spiral exposure scanning is performed in a state where the sub-scan feeding in parallel with the axial direction of the drum is set as continuous feeding.

49. The multi-beam exposure scanning apparatus according to claim 48, characterized in that
the exposure head has a beam group arrangement which is set so that a gap including at least one pixel is provided between the preceding first beam group in exposing the same scanning lines a plurality of times, and the subsequent second beam group.

50. A multi-beam exposure scanning apparatus comprising:
an exposure head configured to engrave a surface of an object by simultaneously irradiating the object with a plurality of light beams;
a scanning device which moves the object and the exposure head relative to each other to expose and scan same scanning lines a plurality of times;
a first exposure scanning control device which effects a first exposure scanning operation to form a first edge section along one direction of a first direction and a second direction different from the first direction with a first beam group, among edge sections of a planar shape to be left on the exposure surface of the object; and
a second exposure scanning control device which effects, after the first exposure scanning operation, a second exposure scanning operation to form a second edge section along the other direction different from the one direction of the first direction and the second direction with a second beam group.

51. The multi-beam exposure scanning apparatus according to claim 50, further comprising:
a fifth exposure scanning control device which effects a fifth exposure scanning operation to draw and engrave, with a fifth beam group, a line drawing of an edge section of the target planar shape to be left on the exposure surface of the object so that only the edge section is formed; and
a sixth exposure scanning control device which effects, after the fifth exposure scanning operation, a sixth exposure scanning operation to expose and scan the outside region of the line drawing with a sixth beam group to form an inclined section around the target planar shape.

52. The multi-beam exposure scanning apparatus according to claim 50, further comprising
an exposure scanning control device which controls the exposure head and the scanning device in such a manner that the target planar shape region to be left on the exposure surface of the object and the peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

53. The multi-beam exposure scanning apparatus according to claim 50, characterized in that
the scanning device includes a drum which is rotated while holding the object on the outer peripheral surface thereof, and a head moving device which moves the exposure head along an axial direction of the drum, and
exposure scanning is performed in a state where the sub-scan feeding in parallel with the axial direction of the drum is set as intermittent feeding by the head moving device.

54. The multi-beam exposure scanning apparatus according to claim 50, characterized in that
the scanning device includes a drum which is rotated while holding the object on the outer peripheral surface thereof, and a head moving device which moves the exposure head along an axial direction of the drum, and
spiral exposure scanning is performed in a state where the sub-scan feeding in parallel with the axial direction of the drum is set as continuous feeding.

55. The multi-beam exposure scanning apparatus according to claim 54, characterized in that
the exposure head has a beam group arrangement which is set so that a gap including at least one pixel is provided between the preceding first beam group in exposing the same scanning lines a plurality of times, and the subsequent second beam group.

56. A multi-beam exposure scanning apparatus comprising:
an exposure head configured to engrave a surface of an object by simultaneously irradiating the object with a plurality of light beams;
a scanning device which moves the object and the exposure head relative to each other to expose and scan same scanning lines a plurality of times;
a first exposure scanning control device which effects a first exposure scanning operation to draw and engrave, with a first beam group, a line drawing of an edge section of a target planar shape to be left on the exposure surface of the object so that only the edge section is formed; and
a second exposure scanning control device which effects, after the first exposure scanning operation, a second exposure scanning operation to form an inclined section around the target planar shape by exposing and scanning the outside region of the line drawing with a second beam group.

57. The multi-beam exposure scanning apparatus according to claim 56, further comprising
an exposure scanning control device which controls the exposure head and the scanning device in such a manner that the target planar shape region to be left on the exposure surface of the object and the peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

58. The multi-beam exposure scanning apparatus according to claim 56, characterized in that
the scanning device includes a drum which is rotated while holding the object on the outer peripheral surface thereof, and a head moving device which moves the exposure head along an axial direction of the drum, and
exposure scanning is performed in a state where the sub-scan feeding in parallel with the axial direction of the drum is set as intermittent feeding by the head moving device.

59. The multi-beam exposure scanning apparatus according to claim 56, characterized in that
the scanning device includes a drum which is rotated while holding the object on the outer peripheral surface thereof, and a head moving device which moves the exposure head along an axial direction of the drum, and
spiral exposure scanning is performed in a state where the sub-scan feeding in parallel with the axial direction of the drum is set as continuous feeding.

60. The multi-beam exposure scanning apparatus according to claim 59, characterized in that
the exposure head has a beam group arrangement which is set so that a gap including at least one pixel is provided between the preceding first beam group in exposing the same scanning lines a plurality of times, and the subsequent second beam group.

61. A multi-beam exposure scanning apparatus comprising:
an exposure head configured to engrave the surface of an object by simultaneously irradiating the object with a plurality of light beams;
a scanning device which moves the object and the exposure head relative to each other to expose and scan same scanning lines a plurality of times; and
an exposure scanning control device which controls the exposure head and the scanning device in such a manner that a target planar shape region to be left on an exposure surface of the object and a peripheral region of the target planar shape region are set as a first region, and the region outside the first region is set as a second region, that the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and that the second region is subjected to non-interlace exposure which performs engraving with a beam group having an adjacent beam interval equal to the scanning line interval.

62. The multi-beam exposure scanning apparatus according to claim 61, characterized in that
the scanning device includes a drum which is rotated while holding the object on the outer peripheral surface thereof, and a head moving device which moves the exposure head along an axial direction of the drum, and
exposure scanning is performed in a state where the sub-scan feeding in parallel with the axial direction of the drum is set as intermittent feeding by the head moving device.

63. The multi-beam exposure scanning apparatus according to claim 61, characterized in that
the scanning device includes a drum which is rotated while holding the object on the outer peripheral surface thereof, and a head moving device which moves the exposure head along an axial direction of the drum, and
spiral exposure scanning is performed in a state where the sub-scan feeding in parallel with the axial direction of the drum is set as continuous feeding.

64. The multi-beam exposure scanning apparatus according to claim 63, characterized in that
the exposure head has a beam group arrangement which is set so that a gap including at least one pixel is provided between the preceding first beam group in exposing the same scanning lines a plurality of times, and the subsequent second beam group.

65. A manufacturing method of a printing plate characterized by comprising:
engraving the surface of a plate material corresponding to an object by the multi-beam exposure scanning method for exposing and scanning same scanning lines a plurality of times by simultaneously irradiating an object with a plurality of light beams to engrave a surface of the object, the method comprising:
a first exposure scanning process of forming a first shape, which defines an outline shape of a target planar shape to be left on an exposure surface of the object and an inclined section around the target planar shape, with a first beam group; and
a second exposure scanning process of forming a second shape, which defines a final shape of the target planar shape and the inclined section around the target planar shape, by exposing and scanning with a second beam group the same scanning lines as the scanning lines exposed and scanned in the first exposure scanning process to obtain the printing plate.

66. A manufacturing method of a printing plate characterized by comprising:
engraving the surface of a plate material corresponding to an object by a multi-beam exposure scanning method for exposing and scanning same scanning lines a plurality of times by simultaneously irradiating the object with a plurality of light beams to engrave a surface of the object, the method comprising:
a first exposure scanning process of forming a first edge section along one direction of a first direction and a second direction different from the first direction with a first beam group, among edge sections of a target planar shape to be left on the exposure surface of the object; and
a second exposure scanning process of forming, after the first exposure scanning process, a second edge section along the other direction different from the one direction of the first direction and the second direction with a second beam group to obtain the printing plate.

67. A manufacturing method of a printing plate characterized by comprising:
engraving the surface of a plate material corresponding to an object by a multi-beam exposure scanning method for exposing and scanning same scanning lines a plurality of times by simultaneously irradiating the object with a plurality of light beams to engrave a surface of the object, the method comprising:
a first exposure scanning process of drawing and engraving, with a first beam group, a line drawing of an edge section of a target planar shape to be left on the exposure surface of the object so that only the edge section is formed; and
a second exposure scanning process of forming, after the first exposure scanning process, an inclined section around the target planar shape by exposing and scanning an outside region of the line drawing with a second beam group to obtain the printing plate.

68. A manufacturing method of a printing plate characterized by comprising:
engraving the surface of a plate material corresponding to an object by a multi-beam exposure scanning method for exposing and scanning same scanning lines a plurality of times by simultaneously irradiating the object with a plurality of light beams to engrave a surface of the object, characterized in that
when a target planar shape region to be left on an exposure surface of the object and a peripheral region of the target planar shape region are set as a first region, and the region outside of the first region is set as a second region,
the first region is subjected to interlace exposure in which a beam group having an adjacent beam interval set to N times (N is an integer of two or more) a scanning line interval is used, and in which unexposed scanning lines between exposed scanning lines are successively exposed by performing scanning a plurality of times while scanning lines to be exposed are made different, and
the second region is subjected to non-interlace exposure which performs engraving with a beam group having an adjacent beam interval equal to the scanning line interval to obtain the printing plate.
